(19) United States
(12) Patent Application Publication
(10) Pub. No.: US 2026/0289167 A1
(43) Pub. Date: Sep. 24, 2026

(54) SYSTEM

(71) Applicant: SoftBank Group Corp., Tokyo (JP)

(72) Inventor: Haruka NISHINO, Tokyo (JP)

(73) Assignee: SoftBank Group Corp., Tokyo (JP)

(21) Appl. No.: 19/563,204

(22) Filed: Mar. 11, 2026

(30) Foreign Application Priority Data
Mar. 19, 2025 (JP) 2025-045002

(51) Int. Cl. G06F 40/40; G06F 40/253; G06F 40/268; G06F 40/289; G06F 40/30; G06N 3/0475

(52) U.S. Cl. CPC G06F 40/40; G06F 40/253; G06F 40/268; G06F 40/289; G06F 40/30; G06N 3/0475

(57) ABSTRACT

A system includes a processor that is configured to receive, as an input, a symptom or problem of a user and cause an information processing apparatus to analyze the input, generate a prompt that instructs a generative AI model to analyze the input of the user, input the generated prompt into the generative AI model, and obtain an analysis result from the generative AI model.

### CROSS-REFERENCE TO RELATED APPLICATION

This application is based on and claims priority under 35 USC 119 from Japanese Patent Application No. 2025-045002 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, various information processing systems have been introduced to support users in understanding their own physical and mental conditions. However, conventional systems typically require predefined symptom selections or rigid questionnaires, and are often unable to flexibly interpret free-form natural language descriptions entered by users. As a result, when a user expresses complex or ambiguous symptoms in text, the system may fail to extract meaningful information, may not provide appropriate temporary coping advice, and may not assist the user in deciding whether to seek professional medical care. Furthermore, existing systems that utilize artificial intelligence often treat the AI model as a black box, without appropriately structuring prompts for generative AI models to reliably analyze user inputs, which can lead to unstable or inconsistent analysis results. There is therefore a need for a system that can receive a user's symptom or problem as a free-form input, construct an appropriate prompt for a generative AI model, obtain a stable analysis result, estimate a relevant disease name, propose temporary coping methods, and determine whether the user should visit a medical institution, thereby supporting the user's decision-making in a more accurate and user-friendly manner.

### SUMMARY

In order to solve the above-described problems, an aspect of the present invention provides a system comprising a processor, wherein the processor is configured to receive, as an input, a symptom or problem of a user and cause an information processing apparatus to analyze the input, generate a prompt that instructs a generative AI model to analyze the input of the user, input the generated prompt into the generative AI model, and obtain an analysis result from the generative AI model. The processor is further configured to estimate a corresponding disease name based on the analysis result, and to propose a temporary coping method based on an estimation result of the disease name. In addition, the processor is configured to determine, based on at least the analysis result and the estimated disease name, whether the user should visit a medical institution, and to notify a terminal of the user of a determination result. By automatically generating a suitable prompt for the generative AI model and systematically processing the obtained analysis result to derive a disease name, temporary coping advice, and a visit recommendation, the system enables flexible interpretation of free-form user inputs while providing consistent and practical support for the user's health-related decision-making.

The term “system” refers to an arrangement of one or more hardware and/or software components, including at least a processor, that are configured to execute the functions described in the claims.

The term “processor” refers to any hardware device or combination of devices capable of executing instructions, including but not limited to a central processing unit (CPU), graphics processing unit (GPU), digital signal processor (DSP), microcontroller, or a group of such devices operating together.

The term “user” refers to a human individual who provides an input indicating a symptom or problem and receives information, such as analysis results, temporary coping methods, or visit recommendations, from the system.

The term “symptom or problem” refers to a description, typically expressed in natural language, of a physical, mental, or emotional condition, complaint, or concern experienced by the user.

The term “input” refers to data provided by the user or by a device on behalf of the user, including text representing a symptom or problem, which is received and processed by the system.

The term “information processing apparatus” refers to a hardware and/or software entity, which may be part of or separate from the processor, that executes processing such as analysis, transformation, or interpretation of the user's input.

The term “analyze the input” refers to performing processing on the user's input, including but not limited to parsing, natural language processing, feature extraction, or semantic interpretation, in order to derive information usable for subsequent processing steps.

The term “prompt” refers to a text or structured data string generated by the processor, which instructs a generative AI model regarding how to interpret, analyze, or respond to the user's input.

The term “generative AI model” refers to an artificial intelligence model, such as a large language model or other generative model, that is configured to generate text or other outputs in response to a prompt.

The term “analysis result” refers to information output by the generative AI model in response to the prompt, including but not limited to interpreted symptoms, inferred conditions, or other analytical content derived from the user's input.

The term “disease name” refers to a label or identifier corresponding to a medical condition, disorder, or syndrome that is estimated by the processor based on the analysis result.

The term “temporary coping method” refers to a non-diagnostic, non-treatment suggestion or guidance, such as behavioral strategies or self-care actions, proposed by the processor to help the user manage symptoms on a temporary basis until professional medical care is obtained or the condition improves.

The term “estimate a corresponding disease name” refers to determining, based on the analysis result, at least one candidate disease name that is considered to be associated with the symptoms or problems described in the user's input.

The term “medical institution” refers to a facility or organization at which medical or mental health services are provided by qualified professionals, including but not limited to hospitals, clinics, and counseling centers.

The term “determine whether the user should visit a medical institution” refers to evaluating, based on at least the analysis result and the estimated disease name, whether it is appropriate to recommend that the user seek professional medical or mental health care.

The term “terminal of the user” refers to an electronic device operated by or associated with the user, such as a smartphone, tablet, personal computer, or other communication device, which can receive notifications from the system.

The term “notify a terminal of the user of a determination result” refers to transmitting, from the system to the user's terminal, information indicating the outcome of the determination regarding whether the user should visit a medical institution.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

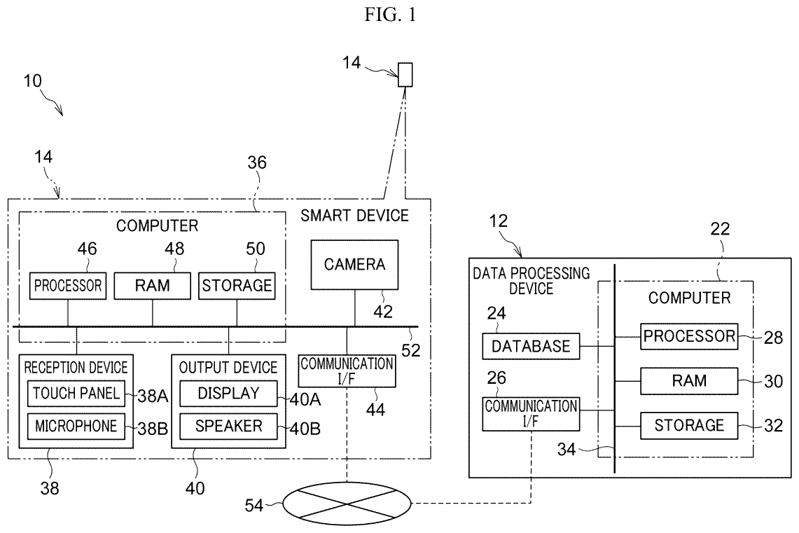

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

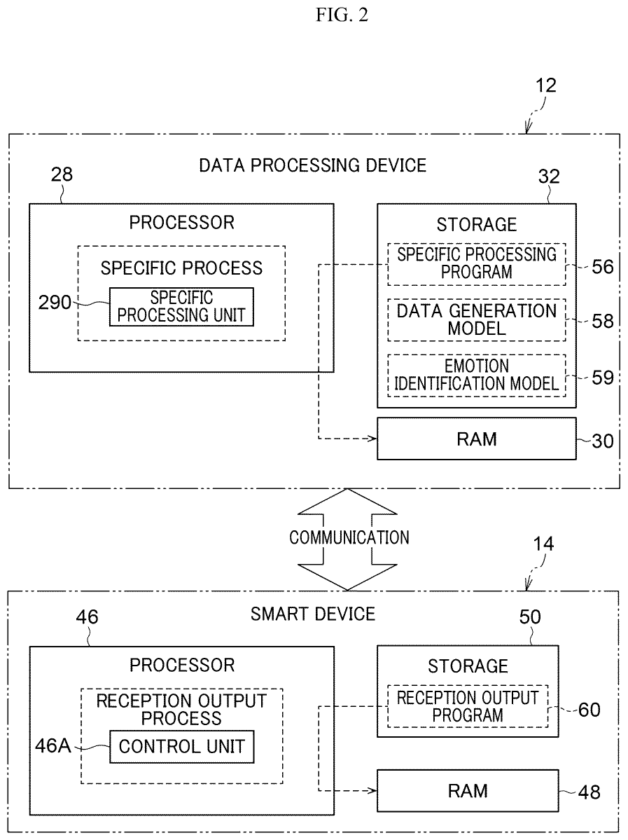

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented symptom analysis systems typically rely on fixed rule sets or static classification models that directly map user input text to a disease label and a small set of canned recommendations. Such architectures suffer from several technical limitations in terms of how computing resources process natural language data, how intermediate representations are generated and used, and how output messages are constructed and transmitted to user terminals.

First, in many existing systems, the processor handles user symptom text as a monolithic string and performs only coarse-grained analysis. The lack of structured intermediate representations, such as token-level features, important phrase extraction, and severity indices, results in inefficient use of computing resources and reduced accuracy of downstream classification. The processor often cannot flexibly adapt to nuanced variations in user language, leading to misclassification and suboptimal advice. From a computer-technology perspective, this reflects an underutilization of natural language processing pipelines and machine learning models, and causes unnecessary processing overhead or repeated heuristic passes over the same unstructured text.

Second, known systems that incorporate generative artificial intelligence models often use such models in an ad hoc manner. In some cases, the generative model is invoked directly on raw user input, without a well-defined prompt that reflects prior analytical stages, classification results, or retrieved data from storage units. In such configurations, the processor fails to coordinate deterministic analysis components (for example, classification models and database retrieval) with generative components. The generative model must internally re-analyze the raw input, which leads to redundant computation, inconsistent outputs, and unpredictable latency. As a result, the overall pipeline from symptom acquisition to advice generation is not optimized for structured data flow, modularity, or efficient resource utilization.

Third, safety and reliability of generated text are not sufficiently integrated into the system-level architecture. In conventional systems, any safety filtering or post-processing tends to be implemented as a simple keyword filter at the user interface layer, disconnected from the server-side logic that orchestrates machine learning inference and text generation. This fragmented approach makes it difficult for the processor to systematically enforce content policies, to correct or delete inappropriate expressions, and to ensure that only validated text is transmitted back to the terminal. Consequently, the system may return responses that are inconsistent with medical guidance policies or that contain harmful or misleading suggestions.

Fourth, many existing implementations do not tightly couple secure communication mechanisms with the internal processing stages on the server. The communication stack and the analysis pipeline are often designed independently, so that symptom information can be exposed to auxiliary components or logging subsystems in plain text before or after analysis. This disjointed design reduces the robustness of privacy protection and increases the risk that sensitive health-related data will be mishandled. From a networked-computing perspective, the lack of an integrated scheme for secure acquisition, structured processing, and secure return transmission jeopardizes end-to-end confidentiality and integrity of the data flow.

Fifth, traditional systems frequently treat database retrieval of response templates and generation of user-facing messages as separate, sequential tasks that do not influence each other at the representation level. The processor may first retrieve static advice text from a storage unit and then independently generate additional text via a generative model, or vice versa, without using the retrieved content as structured input to the generative model. This separation prevents the system from exploiting the strengths of both approaches: deterministic, curated advice from storage and flexible, context-aware elaboration from a generative model. The absence of a unified, prompt-based integration means that the processor cannot easily orchestrate consistent, personalized, and policy-compliant output.

Accordingly, there is a need for a computer-implemented system in which a processor is configured to (i) perform structured natural language processing on symptom information to derive intermediate feature representations, (ii) execute a classification model to determine a disease-related state and a severity index, (iii) retrieve associated temporary response information from a storage unit, (iv) construct a prompt sentence that explicitly encodes these analytical results and retrieved information as input to a generative information processing model, (v) obtain generated text and apply systematic safety determination and correction at the server side, and (vi) transmit integrated response information back to the terminal via a secure communication scheme. By architecting the processing pipeline in this manner, the invention aims to improve the technical functioning of the computer system itself, including more efficient and accurate handling of natural language input, more reliable orchestration of heterogeneous models, and safer, more controlled generation of user-facing content.

The specific processing by the specific processing unit 290 of the data processing device 12 in Example 1 is realized by the following means.

The present invention provides a server comprising a processor that is configured to receive symptom information of a user from a terminal via a secure communication scheme, perform natural language processing on the symptom information to divide the symptom information into word sequences, extract important phrases based on part-of-speech information and grammatical information, and convert the important phrases into numerical feature values, input the numerical feature values to a machine learning model to estimate a classification result representing a disease-related state and an index representing severity of the symptoms, acquire, from an information storage unit, temporary response information associated with the disease-related state based on the classification result and the index and generate analysis information including the temporary response information and consultation recommendation information, generate a prompt sentence that instructs a generative information processing model regarding analytical content and output format based on the symptom information, the classification result, the index, and the temporary response information, input the prompt sentence to the generative information processing model to obtain generated text including an empathetic explanation sentence and an action suggestion sentence, perform a safety determination process on the generated text to delete or correct an inappropriate expression according to a predetermined condition, generate response information by integrating the generated text with the analysis information, and transmit the response information to the terminal via the secure communication scheme so that the terminal presents the response information to the user by a display unit. This enables coordinated use of structured natural language processing, deterministic machine learning classification, database retrieval, and prompt-based generative output within a single server-side processing pipeline, thereby improving computational efficiency, enhancing accuracy and consistency of disease-related estimation and recommendations, and increasing reliability and safety of user-facing content transmitted over a secure network connection.

The term “symptom information” refers to text data or equivalent structured data describing a physical or mental condition of a user, including subjective complaints, perceived problems, or health-related states provided by the user through a terminal.

The term “terminal” refers to an electronic device operated by a user, such as a computing device with an input interface and a display interface, that is capable of sending symptom information to a server and receiving response information from the server over a communication network.

The term “server” refers to one or more computing devices, including associated hardware and software resources, that are configured to receive symptom information from terminals, process the symptom information using programmed instructions, and transmit response information back to the terminals.

The term “processor” refers to one or more processing units, such as a central processing unit or a graphics processing unit, configured to execute programmed instructions for performing natural language processing, machine learning inference, data retrieval, generative text processing, safety determination, and communication control.

The term “secure communication scheme” refers to a communication protocol or mechanism that provides confidentiality, integrity, and, optionally, authentication for data transmitted between the terminal and the server, and that includes, for example, encryption and verification procedures.

The term “communication control unit” refers to a functional component implemented by hardware, software, or a combination thereof, which manages the establishment, maintenance, and termination of network connections, as well as the sending and receiving of data under the secure communication scheme.

The term “natural language processing” refers to a set of computational techniques for analyzing, interpreting, and transforming human language data, including operations such as tokenization, part-of-speech tagging, syntactic analysis, phrase extraction, and semantic feature generation.

The term “word sequences” refers to ordered sets of language units obtained from symptom information, such as tokens, words, or subword units, which can be processed individually or in groups to derive linguistic or semantic features.

The term “important phrases” refers to selected subsets of word sequences that are determined, based on linguistic or statistical criteria, to be particularly relevant for characterizing the user's symptom information or for downstream classification tasks.

The term “part-of-speech information” refers to data indicating grammatical categories associated with tokens or words, such as nouns, verbs, adjectives, or adverbs, which are used to support linguistic analysis and phrase extraction.

The term “grammatical information” refers to data that represents syntactic or structural relationships among tokens or phrases, such as dependency relations, phrase boundaries, or sentence structures, used to identify important phrases.

The term “numerical feature values” refers to data in numerical form, such as vectors, matrices, or tensors, generated from linguistic units or phrases, which can be input to a machine learning model for performing classification or prediction.

The term “machine learning model” refers to a computational model that has been trained using sample data to learn parameters or patterns and that, when provided with numerical feature values, outputs results such as classifications, predictions, or scores.

The term “classification result” refers to an output of the machine learning model that indicates one or more categories or labels associated with the symptom information, including a disease-related state or a condition type inferred from the processed data.

The term “disease-related state” refers to a category or label representing a possible medical or health condition, mental or physical, that is inferred by the machine learning model based on the symptom information and numerical feature values.

The term “index representing severity of the symptoms” refers to a numerical or categorical value that indicates the degree or level of seriousness of the user's symptoms, derived from the machine learning model output or rule-based evaluation.

The term “information storage unit” refers to a storage resource, such as a memory device or database system, configured to store data including temporary response information, disease-related states, and other information used by the server during processing.

The term “temporary response information” refers to advice data or guidance data that is associated with a disease-related state and is intended to provide short-term or interim measures for alleviating or managing the user's symptoms.

The term “analysis information” refers to a structured set of data generated by the processor, which includes at least the temporary response information, the classification result, the index representing severity of the symptoms, and consultation recommendation information.

The term “consultation recommendation information” refers to data that indicates whether the user should visit a medical institution and, if applicable, the urgency or timing of such a visit, based on the classification result and the severity index.

The term “prompt sentence” refers to a text string or equivalent representation that encodes instructions, context, and desired output conditions for a generative information processing model, and that is generated based on at least the symptom information, classification result, severity index, and temporary response information.

The term “generative information processing model” refers to a model, such as a generative artificial intelligence model, configured to produce new text or other data outputs in response to an input prompt sentence by performing probabilistic or learned sequence generation.

The term “generated text” refers to one or more text segments produced by the generative information processing model in response to the prompt sentence, including natural language explanations, suggestions, or other user-oriented content.

The term “empathetic explanation sentence” refers to a portion of the generated text that explains a disease-related state or symptom context in user-friendly terms while expressing understanding or consideration of the user's emotional state.

The term “action suggestion sentence” refers to a portion of the generated text that proposes specific activities, coping strategies, or behavioral steps for the user to take in response to the inferred disease-related state or symptoms.

The term “safety determination process” refers to a processing step in which the generated text is evaluated according to predetermined criteria to determine whether the text includes inappropriate, harmful, or policy-violating content.

The term “inappropriate expression” refers to text content that is determined, based on safety rules or policies, to be unsuitable for presentation to the user, such as content that is harmful, misleading, offensive, or non-compliant with predetermined constraints.

The term “predetermined condition” refers to one or more rules, thresholds, or criteria established in advance that are used to decide whether parts of the generated text must be deleted, corrected, or otherwise modified during the safety determination process.

The term “response information” refers to data generated by the processor that includes at least part of the generated text, the analysis information, and any safety-based modifications, and that is intended to be transmitted to the terminal for presentation to the user.

The term “display unit” refers to a hardware and software combination in the terminal, such as a screen and associated control logic, that presents the response information, including generated text and analysis results, in a human-perceptible form to the user.

In one embodiment, a server, a terminal, and a user cooperate to implement the claimed system. The server includes at least one processor, a memory, a network interface, and a non-transitory storage medium. The server executes program modules that implement secure communication control, natural language processing, feature generation, machine learning classification, prompt sentence construction, generative AI model interaction, safety determination, and response generation. The terminal includes at least one processor, a display unit, an input unit, a memory, and a communication interface. The user operates the terminal to input symptom information and to view response information generated by the server.

The server uses a general-purpose operating system, such as a UNIX-like operating system, and executes an application framework such as a web framework. The server uses a network stack compliant with standard transport and application protocols. The server uses software libraries for text processing, such as a syntactic and semantic analysis library, and software libraries for machine learning, such as a neural network framework. The server uses a data storage system, such as a relational database, to store mappings between disease-related states and temporary response information. The server optionally uses a separate generative AI model hosting environment, which may be provided by a remote computing service or by a local inference engine.

The terminal executes an application program, such as a native application or a web application, that provides a graphical user interface. The terminal displays a text input field, control buttons, and a result display area. The terminal acquires symptom information as free-form text typed by the user. The terminal validates the symptom information locally, for example by checking the length and encoding, and then transmits the symptom information to the server using a secure communication scheme. The terminal uses a transport layer security protocol to encrypt outbound traffic and to authenticate the server. The terminal receives response information from the server and renders it on the display unit in a human-readable form, such as paragraphs of explanation text and lists of recommended actions.

The server acquires symptom information as text data transmitted from the terminal. The server stores the received text temporarily in a protected memory region. The server applies natural language processing to the symptom information. In one implementation, the server uses a text-analysis library to perform tokenization of the symptom information into word units or subword units, to perform part-of-speech tagging for each token, and to derive grammatical information such as dependency relations between tokens. The server also performs normalization, including case folding, whitespace normalization, and replacement of personally identifiable terms with generic tokens, in order to reduce noise and to improve feature consistency.

The server extracts important phrases from the processed symptom information. The server uses part-of-speech information and grammatical information to identify candidate phrases, such as noun phrases, verb phrases, and multi-word expressions that describe states, feelings, or behaviors. The server applies a scoring function, such as a frequency-based or inverse-document-frequency-based score, to determine which phrases are important for characterizing the symptom information. The server thus converts the original free-form text into a structured representation comprising a list of important phrases and associated scores.

The server converts the important phrases into numerical feature values. In one embodiment, the server uses a neural embedding model, such as a word embedding model or a sentence embedding model, that maps tokens or phrases into real-valued vectors. The server loads a set of embedding parameters stored in the memory. The server multiplies token indices by embedding matrices to obtain dense vector representations. The server aggregates phrase vectors, for example by averaging or by applying an attention mechanism, to form a fixed-length feature vector that represents the entire symptom information. The server uses a numerical array library to create and manipulate these feature vectors as tensors residing in CPU memory or GPU memory.

The server inputs the numerical feature values to a machine learning model. In one embodiment, the machine learning model is a feedforward neural network comprising an input layer, one or more hidden layers, and an output layer. Each layer includes a weight matrix and a bias vector. The server applies nonlinear activation functions, such as rectified linear units, at the hidden layers. The server uses a softmax function at the output layer to obtain probability values for each candidate disease-related state. In another embodiment, the server uses a transformer-based encoder architecture that processes the feature sequence using self-attention layers and produces a pooled representation that feeds into a classification head.

The server has trained the machine learning model in advance using supervised learning on historical symptom data and corresponding labels. During training, the server uses a loss function, such as cross-entropy loss, to measure the difference between predicted class probabilities and ground-truth disease-related labels. The server updates the model parameters by gradient-based optimization, such as stochastic gradient descent or an adaptive method. The server may perform data augmentation during training by paraphrasing input sentences, adding noise, or randomly masking tokens to improve robustness. After training, the server stores the trained model parameters in a non-transitory storage medium.

At runtime, the server performs a forward pass through the trained machine learning model using the numerical feature values derived from the current symptom information. The server outputs a classification result, which includes a predicted disease-related state and optionally a probability distribution over multiple states. The server also outputs an index representing severity of the symptoms. The severity index may be output by an additional regression head or classification head attached to the penultimate layer of the neural network. The server thus simultaneously obtains both a disease-related state and a severity index from the same feature representation.

The server uses the classification result and the severity index to access an information storage unit. The server connects to a data storage system through a driver or an access library. The server formulates a query that includes the predicted disease-related state as a key. The server retrieves one or more records that store temporary response information for that state. The temporary response information is stored as text data or structured records that contain short advice sentences or sets of recommended actions. The server may store multiple candidate pieces of temporary response information, each associated with constraints such as severity ranges, patient context, or regional considerations.

The server generates analysis information by combining the classification result, the severity index, the retrieved temporary response information, and consultation recommendation information. The server determines the consultation recommendation information according to a rule set that maps severity index values to visit instructions. For example, if the severity index exceeds a threshold, the server may determine that immediate consultation is recommended. If the severity index is moderate, the server may determine that consultation is recommended if symptoms persist for a specified duration. These rules are stored as configuration data and are applied deterministically by the processor. The server creates a structured analysis record, which includes fields for disease-related state, severity index, temporary response entries, and consultation recommendation.

The server constructs a prompt sentence for a generative AI model based on the analysis information and the original symptom information. The server uses a prompt-generation module that arranges text segments in a predefined template. The server inserts the original user symptom description, the predicted disease-related state, the computed severity index, and the retrieved temporary response information into this template. In one example, the server generates a prompt sentence of the following form:

“The user has entered the following symptom description: ‘Recently, I don't feel like doing anything.’

A machine learning model has predicted the likely condition: depression (probability 0.82) and assessed the severity as moderate.

The database suggests temporary coping methods such as deep breathing, short walks, and maintaining a simple daily routine.

As a mental health support assistant, please:
1) Briefly explain to the user, in empathetic and simple language, what this possible condition (depression) may mean.
2) Provide 3-5 concrete, practical coping suggestions based on the database advice and your own knowledge.
3) Clearly state when the user should visit a medical institution, in particular if symptoms persist for more than two weeks or worsen.”
In another example, the server generates a prompt sentence of the following form:

“The user wrote: ‘In the morning, I find it very hard to get out of bed.’

A classification module inferred a possible depressive state and a moderate severity level.

Temporary coping methods include deep breathing, going for a short walk in daylight, and talking to a trusted person.

Generate a short, empathetic explanation and list at least three specific coping actions, and indicate under what conditions the user should seek professional medical help.”

The server transmits the prompt sentence to a generative AI model. In one embodiment, the generative AI model is a large-scale language model implemented as a multi-layer transformer network with self-attention mechanisms. The generative AI model comprises multiple attention blocks, each with query, key, and value projections, and feedforward sub-layers. The generative AI model has been trained using a language modeling objective, such as next-token prediction or masked-token prediction, on a large text corpus. The model parameters are stored on one or more computing devices and are accessed via an application programming interface.

The server sends the prompt sentence to the generative AI model through the network interface or through an internal call if the model is hosted on the same server. The server receives generated text from the generative AI model. The generated text typically includes an empathetic explanation sentence that describes the inferred condition in plain language and one or more action suggestion sentences that propose specific coping steps. The generative AI model uses the structure of the prompt sentence, including explicit instructions and contextual information, to produce output that is consistent with the classification result and the retrieved temporary response information.

The server performs a safety determination process on the generated text. The server uses one or more rule-based filters and optionally a lightweight secondary classifier to evaluate the generated text for inappropriate expressions. The server maintains a set of safety rules, such as forbidden terms, prohibited instruction patterns, and constraints on medical advice language. The server scans the generated text and identifies any segments that match unsafe patterns. The server deletes or corrects these segments. For example, if the generated text contains an instruction that conflicts with safety policy, the server may replace that sentence with a safer alternative retrieved from a curated response repository. The server thus ensures that only text conforming to predetermined safety conditions is included in the final response information.

The server integrates the filtered generated text with the analysis information. The server constructs response information that includes at least the disease-related state, the severity index, the temporary response information, the safety-checked generated text, and the consultation recommendation information. The server serializes this response information into a structured format for transmission. The server uses the secure communication scheme to send the response information back to the terminal, maintaining confidentiality and integrity of the data.

The terminal receives the response information and parses it. The terminal displays to the user the disease-related state as a label or heading, followed by the empathetic explanation text, the list of coping actions, and the consultation recommendation. The terminal may format the coping actions as bullet points or interactive elements. The terminal may highlight urgent recommendations in a distinguishable color. The user can read the presented information and choose subsequent actions.

The server achieves technical improvements over conventional systems by enforcing a structured data flow and by coordinating multiple specialized modules. The server reduces redundant natural language processing in the generative AI model because the prompt sentence already encodes classification results, severity indices, and curated temporary response information. The generative AI model therefore does not need to infer these elements solely from raw user text. This modular separation reduces computational load in the generative AI stage and improves overall system latency.

The server improves accuracy and consistency by binding the generative AI output to deterministic analysis results. The classification model produces a disease-related state and a severity index based on explicitly defined feature transformations and learned parameters, and the storage unit provides curated response information. The generative AI model receives these outputs as part of the prompt sentence, which constrains its generation space.

Consequently, the server reduces variability and improves alignment between generated explanations and underlying analytic evidence, thereby enhancing reliability of the output.

The server achieves technical effects in data management by representing symptom information as numerical feature vectors and by associating these vectors with disease-related states and severity indices. The server can log these intermediate representations and classification outcomes, instead of logging full natural language text, for monitoring and model improvement while reducing exposure of sensitive information. The feature-based logging improves storage efficiency and facilitates statistical analysis of model performance.

The server improves computational efficiency by employing a single forward pass through a multi-head neural network to obtain both disease-related state and severity index, rather than executing separate models in sequence. The server also reduces network communication load by packaging analysis information and generative text results into a single response message, instead of managing multiple request-response cycles between the terminal and separate external services.

The server operates using technical rules and algorithms that are distinct from human mental processes. For example, the server uses vector-space embeddings, gradient-based optimization, and transformer architectures to process language, which are not typical of human reasoning patterns. The server applies quantifiable decision thresholds on probability scores and severity indices to trigger specific consultation recommendations. The server uses safety rules and pattern-matching algorithms to filter generated text systematically. These algorithmic processes leverage the capabilities of the computing hardware and improve processing speed, classification accuracy, and control over generated content beyond what manual human workflows can achieve at scale.

In alternative embodiments, the server may use different neural architectures, such as convolutional neural networks or recurrent neural networks, to implement the classification model. The server may also use different feature extraction techniques, such as character-level embeddings or subword tokenization, to handle misspellings and out-of-vocabulary terms. The server may adjust the structure of the prompt sentence to include additional fields, such as user demographic attributes or historical interaction summaries, while still maintaining the principle of embedding structured analytic results into the prompt. The server may execute the generative AI model on a local accelerator device instead of a remote service to reduce latency and to allow tighter integration of safety filters.

In another embodiment, the server partitions processing across multiple physical machines, such that one machine concentrates on natural language processing and feature extraction, another machine concentrates on machine learning classification, and a third machine hosts the generative AI model. The server-side components then communicate using an internal secure protocol. This distributed design scales the system to handle large numbers of concurrent symptom analyses while preserving the described data flow and technical advantages.

In yet another embodiment, the terminal may implement additional local processing, such as basic keyword detection or user interface adaptations, but the core operations of structured text analysis, classification, prompt sentence generation, generative processing, and safety determination remain on the server. This allocation ensures that sensitive model parameters and curated safety policies are centrally managed and updated, while the terminal acts primarily as an input and output device.

By implementing these embodiments, the server, the terminal, and the user collectively realize a system that not only automates aspects of symptom interpretation and advice presentation, but also improves the underlying computer-implemented processing of natural language, feature generation, model inference, and generative content control. The explicit architectural choices, data structures, and algorithmic flows described above lead to measurable improvements in processing speed, output consistency, data protection, and computational efficiency, thereby providing a concrete technical solution rather than an abstract idea.

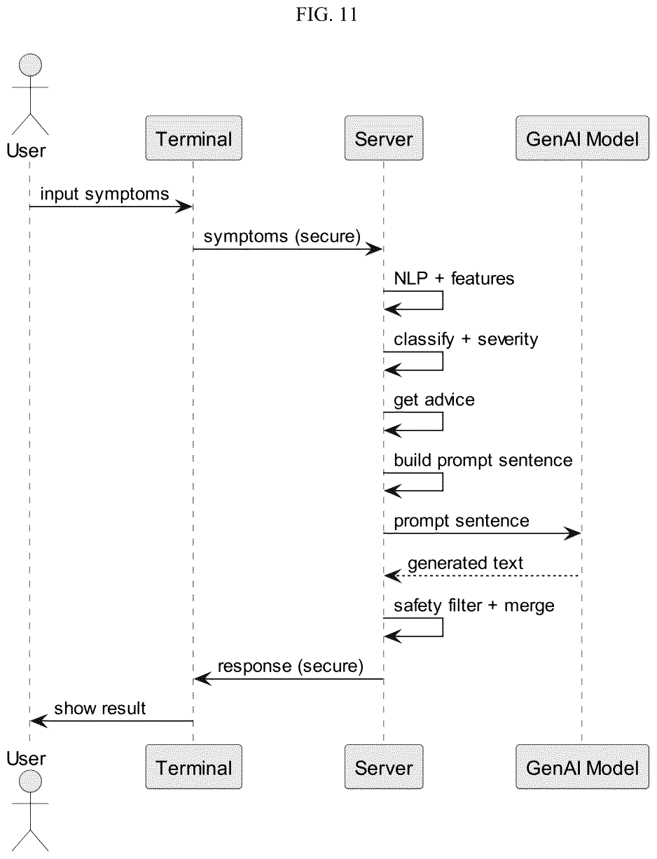

The following describes the processing flow using FIG. 11.

### Step 1

The user operates the terminal to input symptom information.

The user views a text input field on the terminal display and types a free-form description of symptoms, such as “Recently, I don't feel like doing anything.”

The terminal receives the text as input from the keyboard or touch interface and validates it, for example by checking that the character length is within a predetermined range and that the encoding is valid.

The terminal outputs validated symptom text data, typically as a character string or byte sequence, to an internal buffer for further processing.

### Step 2

The terminal transmits the symptom information to the server via a secure communication scheme.

The terminal takes the validated symptom text as input and constructs a request message, for example an application-layer message that includes a user identifier and the symptom text.

The terminal uses a communication stack implementing a secure protocol to encrypt the request and to establish a secure session with the server.

The terminal outputs an encrypted data packet stream containing the symptom text and metadata to the network interface, which forwards the packet stream to the server.

### Step 3

The server receives and decodes the symptom information.

The server takes the encrypted data packet stream as input through its network interface and terminates the secure communication protocol, thereby decrypting the payload.

The server parses the request message to extract fields such as the user identifier and the symptom text.

The server outputs a structured representation of the request, including the plain-text symptom information and associated identifiers, to a request-handling module.

### Step 4

The server performs normalization and tokenization of the symptom information.

The server takes the plain-text symptom information as input and applies text normalization operations, such as converting characters to a canonical case, removing redundant whitespace, and replacing particular patterns with placeholder tokens.

The server then uses a natural language processing library to perform tokenization, which divides the normalized text into a sequence of tokens (for example, words or subword units).

The server outputs a token sequence data structure, such as a list of token objects, each with surface form and position information.

### Step 5

The server performs part-of-speech tagging and grammatical analysis.

The server takes the token sequence as input and applies a tagging algorithm implemented in the natural language processing library.

The server assigns a part-of-speech tag (such as noun, verb, adjective, or adverb) to each token and performs grammatical analysis, for example by constructing a dependency tree or phrase structure that represents syntactic relations.

The server outputs an annotated token sequence, in which each token is associated with part-of-speech information and grammatical relations, and a syntactic structure describing dependencies among tokens.

### Step 6

The server extracts important phrases from the annotated token sequence.

The server takes the annotated token sequence and syntactic structure as input and identifies candidate phrases, such as noun phrases and verb phrases, by traversing the syntactic tree and applying selection rules based on part-of-speech patterns.

The server calculates scores for each candidate phrase using statistical measures such as frequency or inverse-document frequency, and discards phrases whose scores do not satisfy a threshold.

The server outputs a set of important phrases with associated scores, represented as a list of phrase records.

### Step 7

The server converts important phrases into numerical feature values.

The server takes the set of important phrases as input and uses a neural embedding module to map each phrase into a dense numerical vector.

The server looks up or computes an embedding vector for each token in the phrase and applies an aggregation operation, such as averaging or attention-weighted summation, to obtain a single vector per phrase.

The server then aggregates phrase-level vectors into a fixed-length feature vector representing the entire symptom description, for example by concatenation or weighted averaging.

The server outputs one or more numerical feature vectors, such as floating-point arrays or tensors, that capture semantic information about the symptom information.

### Step 8

The server performs disease-related state classification and severity estimation.

The server takes the numerical feature vectors as input and feeds them into a trained machine learning model, such as a neural network classifier with one or more hidden layers.

The server performs a forward computation that multiplies the feature vectors by learned weight matrices, adds bias terms, and applies nonlinear activation functions, ultimately computing output values representing class scores for disease-related states and a value or distribution representing severity.

The server applies a softmax or similar normalization to obtain class probabilities and applies thresholds or an argmax operation to select a predicted disease-related state.

The server outputs a classification result, including the predicted disease-related state and associated probabilities, and an index representing severity of the symptoms, such as a discrete severity level or a continuous severity score.

### Step 9

The server retrieves temporary response information and generates consultation recommendation information.

The server takes the classification result and severity index as input and forms a query to an information storage unit, using the predicted disease-related state as a key.

The server sends this query to a data storage system, which returns one or more records containing temporary response information, such as short advice texts linked to the disease-related state and optionally filtered by severity ranges.

The server applies a rule set to the severity index, comparing it against preconfigured thresholds to determine whether visiting a medical institution is recommended and, if so, with what urgency.

The server outputs analysis information that includes the disease-related state, the severity index, the retrieved temporary response information, and the consultation recommendation information.

### Step 10

The server constructs a prompt sentence for a generative AI model.

The server takes as input the original symptom information, the classification result, the severity index, and the temporary response information contained in the analysis information.

The server composes a prompt sentence by inserting these elements into a predefined textual template that specifies roles, required explanation style, number of coping suggestions, and instructions regarding medical consultation guidance.

The server concatenates text segments and performs formatting operations to generate a coherent natural language prompt sentence that explicitly describes the analysis results and required output format for the generative AI model.

The server outputs the fully formed prompt sentence as a text string suitable for input to the generative AI model.

### Step 11

The server obtains generated text from the generative AI model.

The server takes the prompt sentence as input and sends it to a generative AI model through an application programming interface or an internal inference engine.

The generative AI model processes the prompt sentence by performing multi-layer neural computations, including self-attention and feedforward operations, and incrementally predicts output tokens to form a sequence of generated text.

The server receives the output token sequence from the generative AI model and converts the tokens into a text string representing an empathetic explanation and one or more action suggestions.

The server outputs the generated text as a natural language response segment associated with the current analysis.

### Step 12

The server executes a safety determination process on the generated text.

The server takes the generated text as input and applies one or more safety filters, such as pattern-matching rules, lexical blacklists, and classification models trained to detect unsafe or inappropriate content.

The server scans the generated text to detect segments that violate predetermined safety conditions, such as prohibited medical instructions or harmful language.

The server deletes or replaces the detected segments with alternative safe text, which may be obtained from a curated repository or synthesized according to conservative templates, while leaving compliant text unchanged.

The server outputs a safety-checked text segment that has been filtered and, if necessary, corrected according to safety policies.

### Step 13

The server integrates analysis information and safety-checked generated text into response information.

The server takes the analysis information and the safety-checked text segment as input and merges them into a structured response object.

The server combines fields such as the disease-related state, severity index, temporary response information, consultation recommendation, and the safety-checked empathetic explanation and action suggestions, and arranges them in a format suitable for the terminal to display.

The server serializes this structured response object into a data format compatible with the communication protocol.

The server outputs the serialized response information to the network interface for transmission.

### Step 14

The server transmits the response information to the terminal via the secure communication scheme.

The server takes the serialized response information as input and applies the secure communication protocol to encrypt the data and to associate it with a session established with the terminal.

The server sends the encrypted response data as one or more data packets over the network.

The server outputs the response data stream on the network, where it is delivered to the terminal within the established secure session.

### Step 15

The terminal receives and presents the response information to the user.

The terminal takes the encrypted response data stream as input through its communication interface and uses the secure communication protocol to decrypt the data.

The terminal parses the serialized response information to reconstruct the structured response object, extracting fields such as the predicted disease-related state, severity index, coping suggestions, and consultation recommendation.

The terminal generates a presentation layout and renders the information on the display unit, for example by showing the disease-related state as a title, the empathetic explanation as one or more paragraphs, and the coping suggestions as a list, with the consultation recommendation clearly highlighted.

The terminal outputs the rendered visual content to the user, enabling the user to understand the analysis result and to consider appropriate actions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented advisory systems that rely on fixed rules or static classification models are generally limited to mapping user input directly to pre-scripted outputs. Such systems typically (i) treat natural-language input as coarse categories, (ii) do not dynamically adapt the analysis depth or style of advice to a current mental state of the user, and (iii) do not optimize the interaction between upstream estimation logic and downstream generative AI models. As a result, these systems often generate advice that is generic, poorly contextualized, or even counterproductive when the user is in a heightened stress state or is prone to impulsive purchasing behavior.

From a computer-technology standpoint, conventional architectures commonly pass raw or lightly processed text directly to a generative AI model. This “single-pass” design can cause several technical issues: (1) the generative AI model must internally infer both mental-state classification and advice generation in one step, which increases computational load and latency; (2) the model may overfit to linguistic noise in the raw input, leading to unstable or inconsistent responses; and (3) the server has limited control over how the generative AI model conditions on user state, making it difficult to systematically tune output behavior or to incorporate structured feedback from multiple users. Furthermore, conventional systems rarely use user feedback in a structured manner to update the operating conditions of both the estimation component and the prompt-generation component, leading to technical stagnation in model performance over time.

There is therefore a need for an improved computer-implemented system and server-side processing architecture that: (a) separates feature extraction, mental-state estimation, and generative advice synthesis into coordinated processing stages; (b) generates structured prompt sentences that explicitly encode estimated user mental state and policy constraints before invoking a generative AI model; (c) reduces computational waste by narrowing the generative search space using upstream estimation results; and (d) integrates user feedback as machine-processable signals for updating the operating conditions of the estimation and prompt-generation functions. Such improvements would enhance the technical performance of the underlying information processing apparatus, including improved consistency, controllability, and resource utilization when generating personalized purchasing advice under varying mental states of the user.

The specific processing by the specific processing unit 290 of the data processing device 12 in Application Example 1 is realized by the following means.

The present invention provides a server comprising a processor configured to receive, from a terminal, character information indicating a user state or a user behavior; to perform processing on the received character information using an information processing function for character-string processing to extract feature values relating to an emotion and a behavior and convert the feature values into numerical information; to input the numerical information to a trained estimation function including a generative AI model to obtain an estimation result indicating a mental health state of the user; to generate a prompt sentence to be input to the generative AI model based on the estimation result and the character information; to input the generated prompt sentence to the generative AI model and obtain a response sentence including advice information that influences a purchasing behavior of the user; to transmit the obtained response sentence to the terminal; and to further classify the mental health state of the user as a stress level and a likelihood of occurrence of impulsive purchasing behavior, acquire advice policy information corresponding to a classification result from a storage function, modify contents and an expression format of the prompt sentence based on the advice policy information, receive evaluation information or comment information with respect to the advice information from a plurality of users via the terminal, and update at least one operating condition of the trained estimation function or a function for generating the prompt sentence based on the evaluation information or the comment information. This enables a technically improved, multi-stage server-side processing pipeline in which mental-state estimation and advice generation are decoupled yet interoperating, thereby reducing computational burden on the generative AI model, increasing controllability and stability of generated advice, and allowing the system to iteratively refine estimation and prompt-generation behaviors using structured user feedback, resulting in more efficient and reliable computer-implemented support for purchasing decisions under varying mental states.

The term “processor” refers to a hardware or virtual computation unit, such as a central processing unit or an execution core in a computing device, that executes machine-readable instructions to perform information processing operations.

The term “terminal” refers to a user-side electronic apparatus, such as a portable communication device or a general-purpose computing device, that provides an interface for a user to input information and to receive information from a server.

The term “character information” refers to data representing a sequence of characters or symbols, including natural-language text expressing a user state or a user behavior, which is encoded in a machine-readable form.

The term “user state” refers to a condition associated with a user, including at least an emotional condition, a mental condition, or a psychological condition, that can be inferred from the user's natural-language expressions.

The term “user behavior” refers to an action or a pattern of actions performed or intended to be performed by a user, including at least purchasing behavior, browsing behavior, or usage behavior of a service or application.

The term “information processing function for character-string processing” refers to a software-implemented or hardware-implemented function that analyzes, parses, or transforms character information, including natural-language processing functions such as tokenization, feature extraction, or embedding generation.

The term “feature values” refers to numerical or symbolic attributes derived from character information that represent properties of an emotion or a behavior, and that are suitable for input to a computational model.

The term “numerical information” refers to machine-processable data expressed as numerical values, such as vectors or tensors, that encode feature values extracted from character information.

The term “trained estimation function” refers to a computational model that has been trained using training data to infer or estimate a latent state, such as a mental health state, from numerical information.

The term “generative AI model” refers to an artificial intelligence model that is configured to generate new data, including natural-language text, based on given input information, such as a prompt sentence or context data.

The term “estimation result” refers to output information produced by the trained estimation function that indicates a mental health state or related classification or score for a user.

The term “mental health state” refers to an inferred condition of a user's psychological and emotional well-being, including at least a stress level, an anxiety level, or a risk associated with impulsive behavior.

The term “prompt sentence” refers to a sequence of characters or tokens that is provided as input to a generative AI model to guide or condition the content, style, or constraints of generated output.

The term “response sentence” refers to natural-language text generated by the generative AI model in response to a prompt sentence, and including at least advice information or explanatory information.

The term “advice information” refers to content included in the response sentence that recommends or suggests actions, strategies, or cautions to the user, including recommendations intended to influence purchasing behavior.

The term “purchasing behavior” refers to an action or pattern of actions relating to acquisition of goods or services by a user, including decisions to purchase, timing of purchase, or selection of items to purchase.

The term “stress level” refers to a classification or quantification of a user's stress condition, expressed for example as categories or scores, and inferred by the trained estimation function.

The term “likelihood of occurrence of impulsive purchasing behavior” refers to an estimated probability, degree, or category indicating how likely a user is to engage in purchasing behavior without sufficient deliberation.

The term “classification result” refers to an output produced by the trained estimation function that assigns the user to one or more predetermined classes, such as levels of stress or degrees of impulsive purchasing risk.

The term “storage function” refers to a hardware or software mechanism for retaining and providing data, such as a memory device or a database system, used to store advice policy information, configuration information, or model parameters.

The term “advice policy information” refers to stored data defining rules, strategies, or constraints for generating advice information, including mappings from mental health states or classification results to advice styles or content patterns.

The term “expression format” refers to stylistic and structural properties of text, including length, tone, level of detail, and linguistic style, that characterize how the prompt sentence or response sentence is written.

The term “evaluation information” refers to feedback data provided by a user that indicates a degree of satisfaction, usefulness, or appropriateness of advice information generated by the system.

The term “comment information” refers to user-provided free-form text or structured remarks describing impressions, suggestions, or criticisms regarding the advice information or system behavior.

The term “operating condition” refers to a parameter, configuration, or control setting that influences the operation of the trained estimation function or the function for generating the prompt sentence, including thresholds, weights, or template selection rules.

The server implements a system that analyzes character information representing a user state or user behavior and generates advice information that influences a purchasing behavior of the user. The server executes a program stored in a non-transitory computer-readable storage medium, and the program is implemented, for example, in a general-purpose programming language executed on an operating system running on a physical machine or on a virtual machine. The server includes at least one processor, a main memory, a storage device, a network interface, and optionally an accelerator such as a graphics processing unit.

The server uses a natural language processing library, such as a library equivalent to spaCy, and a machine learning framework, such as a framework equivalent to TensorFlow, as software components for feature extraction and model execution.

The terminal operates as a user-side device, such as a smartphone, tablet, or notebook computer, and executes an application that provides an input interface and an output interface. The terminal includes an input device, such as a touch screen, a display device, a local memory, and a communication module supporting wireless or wired networking. The terminal encodes user input as character information and decodes response sentences received from the server. By offloading high-load processing to the server and maintaining only lightweight interface logic on the terminal, the system reduces computational burden and battery consumption on the terminal while enabling complex analysis on the server.

The user provides natural-language input to the terminal describing the user state or user behavior. The user may enter sentences such as “Recently I feel a lot of stress from my job and I keep buying things online that I do not need,” or “I feel anxious and I tend to purchase items impulsively late at night.” The terminal converts these sentences into encoded character information and transmits them to the server via a secure communication channel. The user then receives, via the terminal, an advice response specifically adapted to the user's mental health state and purchasing tendencies.

The server stores a natural language processing module that includes tokenization, part-of-speech tagging, and vectorization components. The server uses a language model equivalent to a pre-trained word or sentence embedding model, which maps a sequence of tokens to a dense vector representation in a high-dimensional space. The server represents each user input sentence as a sequence of tokens and then as a vector embedding, and also derives auxiliary features such as counts of stress-related expressions, counts of purchasing-related expressions, and sentiment polarity scores. These features are combined into a structured feature vector implemented as a numerical array. By converting free-form natural-language text into a normalized numerical structure, the server improves the stability and reproducibility of downstream computations and reduces sensitivity to lexical variation.

The server executes a trained estimation function implemented as a neural network within the machine learning framework. In one embodiment, the neural network includes an input layer that receives the feature vector, one or more hidden layers that may be fully-connected or may implement recurrent or attention mechanisms, and an output layer that generates scores for multiple mental health state categories. The server may implement an architecture in which an initial dense layer reduces dimensionality of the feature vector, one or more intermediate layers apply nonlinear activation functions, and a final layer outputs a probability distribution over categories such as low stress, moderate stress, and high stress, as well as categories related to impulsive purchasing risk.

The server trains the estimation function in advance using supervised learning. The server maintains a training dataset that includes labeled pairs of feature vectors and known mental health state labels, and uses a loss function such as cross-entropy loss to measure the difference between predicted and true labels. During training, the server performs iterative weight updates using a gradient-based optimization algorithm, such as stochastic gradient descent or an adaptive variant, and may apply regularization techniques, such as dropout or weight decay, to prevent overfitting. The server may apply data augmentation techniques, for example by paraphrasing training sentences or introducing controlled noise, to increase robustness. This training procedure allows the estimation function to learn subtle correlations between linguistic features and mental health states, thereby improving classification accuracy and reducing misclassification compared with simple rule-based or keyword-based methods.

The server uses the trained estimation function in inference mode when character information is received from the terminal. The server computes a forward propagation through the neural network using the current feature vector, obtains an estimation result that includes, for example, a stress level classification and an estimated likelihood of impulsive purchasing behavior, and converts the numeric output into a structured representation that includes fields such as “stress level,” “impulse risk,” and “confidence score.” The server may map continuous probabilities into discrete categories using thresholds stored in a configuration structure. By performing this separation of feature extraction and estimation using an explicitly defined neural architecture, the server achieves a predictable computational profile and can optimize memory allocation and cache usage, which improves processing speed and throughput when handling multiple concurrent user requests.

The server stores advice policy information in a storage component, such as a database or configuration repository. The advice policy information maps combinations of stress level and impulsive purchasing likelihood to parameter sets specifying desired tone, length, and content constraints of advice. For example, an entry may define that for “high stress” and “high impulsive risk,” the advice should be brief, empathetic, and strongly discouraging immediate purchases, whereas for “moderate stress” and “low impulsive risk,” the advice may emphasize long-term budgeting without strong behavioral constraints. The server retrieves the corresponding advice policy record based on the classification result. This separation of estimation and policy mapping allows fine-grained, data-driven control of the way generative output is conditioned, and thus reduces the need to retrain the generative AI model for policy changes.

The server generates a prompt sentence for a generative AI model based on the character information, the estimation result, and the advice policy information. The server constructs the prompt sentence by filling in a template structure with explicit slots such as a summary of the user state, a specification of stress level and impulsive risk, and instructions relating to length and style. For example, the server may create a prompt sentence such as: “The user reports high stress and frequent unnecessary online purchases. Based on this information, generate empathetic, practical advice to help the user avoid impulsive buying, reduce regret, and choose simple, low-cost coping strategies.”

In another example, the server may generate a prompt sentence such as: “The user says: ‘Recently I feel a lot of stress from my job, and I keep buying clothes and gadgets online to feel better, but I regret it later.’ The user is estimated to be in a high-stress state with a high risk of impulsive buying. As a generative AI model, produce short, clear, and empathetic advice that helps the user recognize this pattern, pause before purchasing, and choose non-financial coping strategies such as relaxation, exercise, or social support.”

By explicitly encoding the estimated mental health state and policy constraints into the prompt sentence, the server reduces ambiguity for the generative AI model, which improves generation consistency and reduces computational overhead by narrowing the search space of plausible outputs.

The server executes a generative AI model that receives the prompt sentence as input and generates a response sentence containing advice information. In one embodiment, the generative AI model is a transformer-based language model implemented in the machine learning framework and executed on the server's processor or accelerator. The model includes an embedding layer that converts prompt tokens into vector representations, multiple self-attention layers that compute attention scores between token positions, and feed-forward layers that transform intermediate representations. The server uses a decoding method such as greedy decoding, beam search, or top-k sampling to generate a sequence of output tokens until an end-of-sequence condition is met. The model parameters are either pre-trained on large collections of text and optionally fine-tuned on domain-specific advice examples, or are obtained from a model service accessible through a network.

The server may fine-tune the generative AI model using example pairs of prompt sentences and desired advice outputs. During fine-tuning, the server minimizes a loss function such as token-level cross-entropy and updates model parameters using gradient descent. The server may also adjust hyperparameters such as learning rate, batch size, and sequence length to balance convergence speed and generalization. By aligning the generative AI model with structured prompt formats and target advice styles, the server improves controllability and reduces undesirable variance in generated content.

The server post-processes the generated response sentence to ensure conformity with stored guidelines and constraints. The server may apply text normalization, length truncation, and filtering of expressions that do not satisfy policy rules, using rule-based procedures or secondary classifier components. By implementing post-processing as explicit server-side logic, the system provides deterministic boundaries around model output and ensures that advice information remains within intended technical and safety parameters.

The terminal receives the response sentence, decodes it, and displays it within a graphical interface component. The terminal may also display a summarized mental health state, such as “Current status: high stress, high impulsive risk,” and may present interactive controls for the user to indicate whether the advice was helpful. The terminal stores local state, such as timestamps and identifiers, and transmits feedback information back to the server. By handling only presentation logic and simple local state management, the terminal remains lightweight and platform-agnostic.

The server records evaluation information and comment information from the user in a storage device. The server aggregates such feedback across multiple users and uses it to update operating conditions of the estimation function and the prompt generation function. For example, if advice generated under a certain combination of stress level and impulsive risk consistently receives low evaluation scores, the server may adjust thresholds, modify templates, or retrain mapping parameters between classification results and policy information. The server may also use feedback to update sampling parameters or style tokens used by the generative AI model. In this way, the server implements a feedback-driven control loop that dynamically optimizes internal algorithms and data structures over time, leading to improved accuracy and user satisfaction.

The server thereby provides a technical improvement over conventional systems that simply route user text to a generative model without structured intermediate processing. By implementing a multi-stage pipeline in which feature extraction, mental state estimation, policy mapping, prompt sentence generation, and generative decoding are clearly separated and interconnected, the server can optimize each stage for computational efficiency. The use of numerical feature vectors and trained neural networks in the estimation function reduces noise and variance compared with simple keyword matching, and enables faster, vectorized computation. The explicit policy mapping and prompt construction lower the entropy of the generative task, allowing the generative AI model to converge to relevant advice with fewer decoding steps, which reduces compute time and energy consumption.

The server also improves data management and memory usage by storing structured representations such as feature vectors, classification results, and policy records in well-defined formats. This structure allows the server to index and retrieve records efficiently, apply batch processing for simultaneous inference on multiple users, and compress intermediate data where appropriate. These technical effects are realized in the internal operation of the computing apparatus and are not merely an automation of human decision-making; rather, they constitute an optimization of data representation, algorithmic flow, and hardware utilization that a human operator cannot practically achieve without computational assistance.

The server can be implemented in alternative embodiments. In one embodiment, the estimation function uses a recurrent neural network rather than a transformer. In another embodiment, the feature extraction uses character-level embeddings instead of word-level embeddings, which can increase robustness against spelling errors. In yet another embodiment, the generative AI model is hosted on a separate server and accessed via an application programming interface, and the local server focuses on feature extraction, estimation, and prompt generation. The server may also implement hardware-specific optimizations, such as quantized model weights for reduced-precision arithmetic on specific accelerators, thereby further improving throughput.

The terminal can also take various forms. In one embodiment, the terminal is a head-mounted display that presents advice in augmented reality form, and in another embodiment, the terminal is a vehicle-mounted device that renders advice using voice output. In each case, the terminal operates as a communication and display endpoint, and the main computational processing remains on the server.

The user uses the system to receive context-sensitive advice relevant to purchasing behavior under different mental states. The user can interact with the terminal in natural language without needing to understand underlying computational processes. However, because the server performs structured, multi-stage processing with trained models, the system as a whole achieves higher precision, faster response times, and better resource efficiency than conventional architectures that rely on monolithic, unstructured calls to generative models. The system thus provides a concrete technological solution that improves the operation of computers and networks used for natural-language-based advisory services.

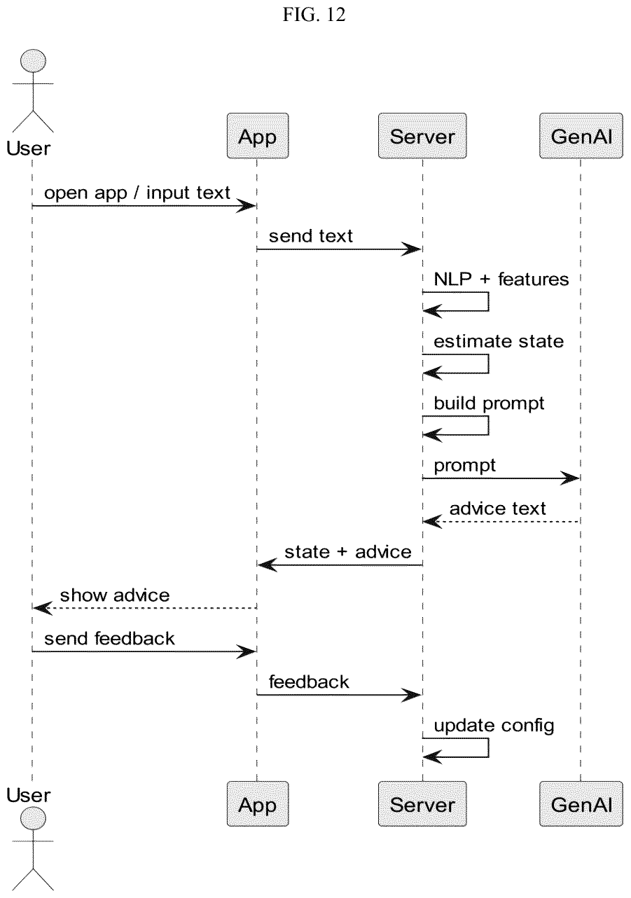

The following describes the processing flow using FIG. 12.

### Step 1

The user operates the terminal to launch an application and input a natural-language description of the user's current state or behavior.

The input of Step 1 is raw user text entered via a touch screen or keyboard, for example, “Recently I feel a lot of stress from my job, and I keep buying things online that I do not really need.”

The terminal converts this input into a character string encoded in a machine-readable format, removes unsupported characters, and stores the cleaned text as the output of Step 1.

### Step 2

The terminal prepares and transmits a request containing the character string to the server.

The input of Step 2 is the cleaned character string produced in Step 1.

The terminal embeds this character string into a structured data format, such as a JSON object, attaches metadata including a user identifier and timestamp, and sends the resulting data packet to the server over a secure communication channel. The output of Step 2 is a network message received by the server that contains the user text and associated metadata.

### Step 3

The server receives the network message and parses the character information.

The input of Step 3 is the network message transmitted from the terminal.

The server uses a communication interface and a protocol stack to extract the message payload, applies a parser to decode the structured data, and retrieves the raw character string representing the user state or behavior. The output of Step 3 is the character string and associated metadata stored in server memory as separate variables or records.

### Step 4

The server performs natural-language preprocessing on the character string to obtain linguistic units.

The input of Step 4 is the character string obtained in Step 3.

The server uses a text-processing module to normalize the text (for example, lowercasing and removal of extra spaces), tokenize the text into words or subword units, and perform sentence segmentation where necessary. The output of Step 4 is a token sequence and, optionally, segmented sentences ready for feature extraction.

### Step 5

The server extracts feature values related to emotion and behavior from the token sequence and converts them into numerical information.

The input of Step 5 is the token sequence from Step 4.

The server applies a natural-language processing function to map each token or the full sentence to one or more embedding vectors, computes auxiliary counts such as the number of stress-related terms and purchasing-related terms, and calculates sentiment scores. The server concatenates or combines these quantities into a numerical feature vector. The output of Step 5 is a structured feature vector consisting of numerical components that represent the emotional and behavioral characteristics of the user's text.

### Step 6

The server supplies the numerical feature vector to a trained estimation function to infer a mental health state of the user.

The input of Step 6 is the feature vector produced in Step 5.

The server executes forward propagation through a neural network by performing matrix multiplications, adding bias terms, and applying nonlinear activation functions, and then computes scores for predetermined mental-state categories such as stress levels and impulsive purchasing risk levels. The output of Step 6 is an estimation result that includes, for example, probability scores or categorized labels such as “high stress” and “high likelihood of impulsive purchasing behavior.”

### Step 7

The server converts the estimation result into a structured mental-state representation and determines classification categories.

The input of Step 7 is the estimation result from Step 6.

The server compares the output scores against threshold values stored in configuration data, maps continuous scores to discrete categories, and populates a data structure with fields such as stress level, impulsive risk, and confidence score. The output of Step 7 is a mental-state object or record that precisely encodes the classified state of the user.

### Step 8

The server acquires advice policy information corresponding to the classified mental state from a storage component.

The input of Step 8 is the mental-state object generated in Step 7.

The server uses keys derived from the stress level and impulsive risk to query a database or configuration store, retrieves matching advice policy entries that specify desired tone, length, and behavioral focus, and loads these policy parameters into working memory. The output of Step 8 is an advice policy record that is associated with the current user's mental state.

### Step 9

The server generates a prompt sentence for a generative AI model by combining the user text, the mental-state representation, and the advice policy information.

The input of Step 9 is the original character string from Step 3, the mental-state object from Step 7, and the advice policy record from Step 8.

The server selects a prompt template from a template repository, inserts into the template a summary of the user's text, explicit labels such as “high stress” and “high impulsive risk,” and instructions derived from the policy record regarding length and style. The server serializes these elements into a single prompt sentence. The output of Step 9 is a structured prompt sentence, for example, “The user reports high stress and frequent unnecessary online purchases. Based on this information, generate empathetic, practical advice to help the user avoid impulsive buying, reduce regret, and choose simple, low-cost coping strategies.”

### Step 10

The server inputs the generated prompt sentence into a generative AI model and computes an advice response.

The input of Step 10 is the prompt sentence produced in Step 9.

The server encodes the prompt sentence into tokens, maps the tokens to embeddings, and performs multiple layers of attention and feed-forward operations within the generative AI model to predict the next tokens in a sequence. The server iteratively selects output tokens according to a decoding policy such as beam search or top-k sampling until an end condition is met. The output of Step 10 is a generated response sentence that contains advice information, for example, “When you feel very stressed, try to pause before making any purchases. Take a few deep breaths or go for a short walk instead of opening shopping sites.”

### Step 11

The server post-processes the generated response sentence according to predefined rules.

The input of Step 11 is the response sentence obtained in Step 10.

The server normalizes spacing and punctuation, enforces maximum length constraints, checks for prohibited or undesired expressions using rule-based filters or classifiers, and if necessary edits or truncates portions that violate policy guidelines. The output of Step 11 is a finalized advice sentence that conforms to system constraints and is ready for presentation to the user.

### Step 12

The server packages the finalized advice sentence and mental-state summary into a response message and transmits it to the terminal.

The input of Step 12 is the finalized advice sentence from Step 11 and the mental-state object from Step 7.

The server constructs a structured response containing fields for mental health state and advice text, serializes this structure, and sends it through the network interface to the terminal using a response protocol. The output of Step 12 is a network message delivered to the terminal that carries the advice information and associated mental-state indicators.

### Step 13

The terminal receives the response message and displays the advice information to the user.

The input of Step 13 is the network message transmitted in Step 12.

The terminal decodes the structured data, extracts the mental-state label and the advice sentence, and updates the user interface to show, for example, “Current status: high stress, high impulsive risk” and the generated advice text in a readable format. The output of Step 13 is a rendered display on the terminal's screen that the user can perceive and act upon.

### Step 14

The user reviews the displayed advice and may provide evaluation information or comment information through the terminal.

The input of Step 14 is the visual or auditory presentation of the advice from Step 13.

The user interacts with interface elements such as rating buttons or a comment text field, and the terminal converts these interactions into structured feedback data. The output of Step 14 is feedback information that encodes the user's assessment of the advice.

### Step 15

The terminal sends the feedback information to the server for further processing.

The input of Step 15 is the feedback data created in Step 14.

The terminal attaches identifiers and timestamps, packages the feedback into a structured message, and transmits it to the server over the communication channel. The output of Step 15 is a feedback message received by the server that associates the given advice with user evaluation or comment content.

### Step 16

The server stores and utilizes the feedback information to update operating conditions of the estimation function and the prompt generation function.

The input of Step 16 is the feedback message received in Step 15.

The server writes the feedback into persistent storage, aggregates it with historical feedback for similar mental-state classifications and prompt templates, and applies analytical procedures to compute performance metrics such as average rating per policy combination.

Based on these metrics, the server adjusts configuration parameters, such as threshold values for classification, mapping rules between mental states and policy entries, or wording patterns in templates. The output of Step 16 is an updated set of operating conditions that influence future executions of the estimation and prompt generation processes, thereby improving accuracy, stability, and user satisfaction over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2.

The units of the system described below are implemented by the data processing device 12 and the smart device 14. The data processing device 12 is called a “server” and the smart device 14 is called a “terminal”.

Conventional computer-implemented health support systems generally rely on fixed rule sets or simple keyword matching to interpret user-entered symptom descriptions. Such systems often treat input text merely as a flat string and do not perform detailed natural language preprocessing, such as tokenization, part-of-speech tagging, or extraction of symptom-related features. As a result, these systems are limited in their ability to accurately capture the nuanced meaning of user descriptions, and they frequently produce coarse or unreliable health-related outputs.

In parallel, recent generative artificial intelligence models have demonstrated powerful capabilities in natural language understanding and text generation. However, typical integrations of such generative models into application systems are architected in an ad hoc manner, where a client or a server sends raw text directly to a generative model with a loosely defined prompt. In these conventional approaches, there is no systematic server-side mechanism to: (i) perform structured linguistic preprocessing of user text, (ii) derive explicit feature information representing symptom patterns, (iii) embed both raw and derived information into a task-specific prompt sentence, and (iv) obtain structured analysis results that can be reliably used for downstream computational decisions. Consequently, the generative model is underutilized as a component of an information processing pipeline and behaves as a black-box text generator, making it difficult to engineer predictable, reproducible, and safe system behavior.

Furthermore, in many known systems, health state estimation, generation of temporary coping content, and determination of whether to recommend a visit to a medical institution are implemented as separate, loosely coupled modules, sometimes using different models or disjoint logic paths. This fragmented architecture causes several technical problems in computer processing, including increased latency due to multiple model invocations, inconsistent interpretation of user input across modules, and complexity in maintaining and updating the overall software stack. Additionally, when generative models are used only peripherally, the server cannot effectively constrain or guide the model toward specific computational tasks, which may result in verbose, irrelevant, or unsafe output.

In view of the foregoing, there is a need for an improved computer-implemented system and server-side processing architecture that: (1) transforms unstructured, user-entered symptom descriptions into structured information and feature information via explicit natural language preprocessing; (2) programmatically generates a task-constrained prompt sentence that incorporates both raw description information and derived feature information; (3) utilizes a generative information processing model not merely as a general text generator, but as a controlled component for producing structured analysis result information including health state estimation information and severity information; and (4) automatically generates response information, including temporary coping content and a determination on whether to recommend a visit to a medical institution, based on these structured analysis results. By addressing these technical issues, the invention improves the way a computer system interprets, processes, and acts upon natural language symptom descriptions, thereby enhancing the reliability, efficiency, and controllability of generative AI-based health support applications.

The specific processing by the specific processing unit 290 of the data processing device 12 in Example 2 is realized by the following means.

The present invention provides a server comprising a processor configured to obtain description information input by a user, execute natural language processing on the description information to perform preprocessing of the description information and to generate structured information and feature information based on the structured information, generate analysis target content including the description information and the feature information, generate a prompt sentence for causing a generative information processing model to analyze the analysis target content, input the prompt sentence to the generative information processing model, cause the generative information processing model to generate analysis result information including health state estimation information relating to a health state of the user and severity information corresponding to the health state estimation information with respect to the analysis target content, obtain the analysis result information, generate response information including temporary coping content based on the analysis result information, and output the response information to a user terminal, and further configured to determine necessity of recommending a visit to a medical institution using the severity information included in the analysis result information and predetermined expressions in the description information as determination conditions, and include a determination result of the necessity in the response information, and still further configured to generate the prompt sentence so as to explicitly indicate at least one task selected from a group consisting of generation of the health state estimation information, generation of the temporary coping content, and determination of the necessity of recommending the visit to the medical institution by the generative information processing model. This enables the server to operate as a structured natural language processing pipeline that systematically transforms unstructured user symptom descriptions into feature-enhanced analysis target content, tightly constrains the generative information processing model via task-specific prompt sentences, and produces consistent, machine-usable analysis result information from a single model invocation, thereby improving computational efficiency, controllability, and reliability of computer-based health state estimation and response generation.

The term “description information” refers to text data or equivalent natural language content that is input by a user to express symptoms, problems, or related conditions and that is supplied to the server for analysis.

The term “natural language processing” refers to a class of computational techniques executed by an information processing apparatus to analyze and transform natural language text, including at least one of tokenization, morphological analysis, part-of-speech tagging, syntactic parsing, and extraction of semantic features.

The term “preprocessing” refers to processing performed prior to application of a generative information processing model, including conversion of raw description information into structured information and feature information suitable for subsequent computational analysis.

The term “structured information” refers to information obtained by organizing elements of the description information into a predefined data structure, such as a list, table, or graph, including at least tokens, linguistic annotations, and extracted phrases.

The term “feature information” refers to numerical values, categorical values, flags, or other machine-usable indicators derived from the structured information and representing properties or patterns of the description information, including at least symptom-related indicators and severity-related indicators.

The term “analysis target content” refers to a data object that includes at least the description information and the feature information and that is provided as a target of analysis by the generative information processing model.

The term “prompt sentence” refers to instruction information expressed in natural language or a structured format that is generated by the processor to specify at least one analysis or generation task to be performed by the generative information processing model with respect to the analysis target content.

The term “generative information processing model” refers to a computational model, implemented in software and executed by hardware resources, that receives the prompt sentence and related input data and generates output information using parameterized statistical or machine learning techniques, including at least a generative artificial intelligence model for natural language processing.

The term “analysis result information” refers to information output from the generative information processing model in response to the prompt sentence, including at least health state estimation information and severity information derived for the analysis target content.

The term “health state estimation information” refers to information indicating an estimated physical or mental condition of the user, expressed as at least one of a label, category, or textual description inferred from the description information.

The term “severity information” refers to information indicating an estimated degree of seriousness or urgency of the health state estimation information, expressed as at least one of a score, level, or class that is machine-readable.

The term “temporary coping content” refers to content that proposes short-term, immediately executable actions or strategies intended to alleviate or manage the estimated health state of the user without constituting a formal medical diagnosis or treatment plan.

The term “response information” refers to information generated by the processor for presentation to the user terminal, including at least the temporary coping content and optionally the health state estimation information, the severity information, and a determination result regarding a visit to a medical institution.

The term “user terminal” refers to an information processing device operated by the user, including at least a communication function and a display function, and configured to transmit description information to the server and to receive and present response information from the server.

The term “medical institution” refers to an organization or facility that provides professional medical services, including at least hospitals, clinics, or equivalent care providers.

The term “necessity of recommending a visit to a medical institution” refers to a determination result indicating whether the user should be advised to seek examination or consultation at a medical institution based on analysis result information and predetermined conditions.

The term “predetermined expressions” refers to specific linguistic patterns, keywords, or phrases defined in advance and used as conditions for determining the necessity of recommending a visit to a medical institution, including at least high-risk or urgent symptom expressions.

The term “task” refers to a processing objective to be executed by the generative information processing model, including at least generation of health state estimation information, generation of temporary coping content, and determination of the necessity of recommending a visit to a medical institution.

In one or more embodiments, a server, a terminal, and a user cooperate to implement a system for estimating a health state and generating temporary coping content based on natural language symptom descriptions, using a generative AI model controlled by a task-specific prompt sentence. The following description illustrates exemplary embodiments that support and enable the claimed invention.

A server uses one or more processors, a main memory, a storage device, and a communication interface. The server executes an operating system such as a general-purpose server operating system, and application software implemented, for example, in a high-level programming language. The server may further use a numerical computation framework such as a tensor computation framework and a machine learning framework such as a deep learning library. The server may employ a natural language processing library such as a general-purpose NLP toolkit and a syntactic/semantic parsing library.

A terminal uses a processor, a memory, a display unit, an input unit, and a communication module. The terminal executes a client application such as a native mobile application or a browser-based application implemented using a web technology stack. The terminal provides a user interface to allow a user to input free-form text describing symptoms or problems. The terminal transmits the input text to the server via a network such as the Internet, using a protocol such as HTTPS. The terminal receives response information from the server and displays the response information on the display unit in human-readable form.

A user operates the terminal to input description information. The user types or dictates natural language text that represents the user's current mental or physical symptoms. For example, the user may input sentences such as:

“Recently, I don't feel like doing anything.”

“In the morning, it is hard to get out of bed and I feel constantly tired.”

The user then submits this description information to the server through the terminal's user interface.

The server receives the description information and stores it temporarily in the memory or storage device together with metadata such as a user identifier, a timestamp, and a language identifier. The server performs natural language preprocessing using a natural language processing library. The server applies tokenization to split the description information into word units or subword units. The server applies part-of-speech tagging to annotate each token with grammatical categories. The server applies lemmatization and dependency parsing to obtain base forms of words and syntactic relations between tokens. The server represents this linguistic information as structured information, for example as a token sequence, tag sequence, dependency tree, and identified phrases stored in a structured data object.

The server derives feature information from the structured information. The server uses rule-based pattern detection and statistical feature extraction to identify symptom-related patterns.

The server may define symptom indicator rules such as:
When a negative auxiliary verb appears with a verb indicating desire or motivation and a generic object such as “anything” or “anything at all,” the server sets a low-motivation feature.
When a phrase structure contains an expression like “hard to get out of bed” or “cannot get up,” the server sets a fatigue or depression-related feature.
When sentiment analysis or polarity scoring based on token-level features falls below a threshold, the server sets a negative affect feature.

The server further converts the description information into a numerical embedding using a text encoder associated with the generative AI model. The server combines these indicators and embeddings into feature information that includes binary flags, categorical values, and continuous-valued vectors. The server stores the feature information in a feature data structure indexed by token positions and symptom categories.

The server constructs analysis target content that includes at least the original description information and the feature information. The analysis target content serves as a unified representation for subsequent processing by the generative AI model. The server then generates a prompt sentence that explicitly defines tasks for the generative AI model. The server composes the prompt sentence by concatenating: (i) an instruction section describing the required tasks; (ii) a section summarizing the derived feature information in textual form; and (iii) a section quoting the user's original description information.

For example, the server may generate a prompt sentence such as:

“Analyze the following user symptoms and estimate the most likely mental or physical health state. Provide a short label, a brief explanation, and a severity score between 0.0 and 1.0.

Detected features: low motivation=true, fatigue_indicator=true, negative_affect=high.

User input: ‘Recently, I don't feel like doing anything.’”

In some embodiments, when temporary coping content is to be generated in addition to health state estimation, the server generates a prompt sentence such as:

“The user is estimated to be in a possible depressive state based on the following symptoms.

Symptoms: ‘Recently, I don't feel like doing anything.’

Detected features: low motivation=true, fatigue_indicator=true, negative_affect=high.
1) Provide a concise label for the likely health state.
2) Provide a brief explanation in 2-3 sentences.
3) Suggest three simple, short-term coping strategies that the user can try immediately, using clear and non-judgmental language.
4) Provide a severity score between 0.0 and 1.0.”

In another embodiment, when determining whether to recommend a visit to a medical institution, the server generates a prompt sentence such as:

“You are given a user's symptom description and detected risk-related features.

Symptoms: ‘In the morning, it is hard to get out of bed and I feel constantly tired.’

Detected features: fatigue_indicator=true, low_energy=true, high_risk_expression=false.

Tasks:
(a) Estimate the user's health state and provide a short label.
(b) Provide a severity score between 0.0 and 1.0.
(c) Based on the severity score and the described symptoms, state ‘YES’ or ‘NO’ to whether the user should be advised to visit a medical institution.”

The server uses a generative AI model as a generative information processing model. In one embodiment, the server loads a neural network model implementing a Transformer architecture with multiple encoder and decoder layers, multi-head self-attention, and feed-forward sublayers. The server stores model parameters, such as weight matrices and bias vectors, in the storage device and loads them into memory at runtime. The server may use a machine learning framework that provides tensor operations, automatic differentiation, and model serialization. The generative AI model is trained in advance on large-scale text data including health-related content, question-answer pairs, and symptom descriptions, using a sequence-to-sequence or language modeling objective.

The server, during training, uses an error function such as cross-entropy loss between predicted token distributions and ground truth target sequences. The server updates model parameters using an optimization method such as stochastic gradient descent with adaptive learning rate adjustment. The server may apply data augmentation by paraphrasing symptom descriptions, masking tokens, or injecting synthetic noise, to improve model robustness. The server may fine-tune the generative AI model on domain-specific corpora containing annotated health state labels, severity scores, and recommended actions, so that the model learns to produce structured output segments in response to prompt sentences.

The server, during inference, encodes the prompt sentence and any necessary analysis target content using a model-specific tokenizer that maps text to token identifiers. The server constructs input tensors containing token identifiers, segment identifiers, and attention masks.

The server feeds these tensors into the generative AI model, which computes attention scores and intermediate representations across multiple layers. The server obtains generated output tokens step-by-step according to decoding algorithms such as greedy decoding, beam search, or nucleus sampling, in combination with constraints on maximum output length and forbidden token sequences.

The server parses the generated output to extract analysis result information in a structured form. The server may require the generative AI model to output results in a specific pattern, for example:

“Health state: [label].

Explanation: [text].

Severity: [numeric value].”

The server scans the generated text for marker strings such as “Health state:”, “Explanation:”, and “Severity:”, and parses segments following the markers. The server converts the severity text into a numeric severity information value and stores the health state label and explanation in structured fields. The server then uses this analysis result information as input for further computation.

The server determines the necessity of recommending a visit to a medical institution using both the severity information and predetermined expressions present in the description information. The server maintains a dictionary of high-risk phrases and patterns, such as expressions indicating self-harm, persistent inability to perform basic activities, or severe physiological symptoms. The server scans the original description information and its structured representation to detect these predetermined expressions. The server applies decision logic such as:
When the severity information exceeds a threshold, the server classifies the case as high severity.
When any predetermined high-risk expression is detected, the server flags the case as high risk regardless of the numeric severity.

The server thus computes a determination result as to whether a medical visit should be recommended. The server converts this determination into textual content to be included in the response information, such as:

“Based on your current symptoms and their severity, we recommend that you consult a medical institution.”

or

“At this time, we do not detect signs that require an immediate medical visit, but if your symptoms persist or worsen, please consider consulting a medical professional.”

The server generates temporary coping content based on the analysis result information, using either a further call to the generative AI model with a specialized prompt sentence, or post-processing of a combined output that includes both health state estimation and coping suggestions. The server may send a prompt sentence such as:

“The user appears to be in a possible depressive state with a severity score of 0.7, based on symptoms: ‘Recently, I don't feel like doing anything.’

Provide three short, practical coping strategies the user can try immediately. Each strategy should be less than 200 characters and should not mention medication or diagnosis.”

The server then receives generated suggestions and filters them using safety and format rules to form temporary coping content. The server aggregates the health state estimation information, severity information, temporary coping content, and the determination on medical visit necessity into response information, and transmits this response information to the terminal.

The terminal receives the response information, parses the structured data, and renders the content on the display. The terminal may display sections for the estimated health state, an explanation of the estimated health state, a list of coping strategies, and a message indicating whether the user should consider visiting a medical institution. The terminal may further allow the user to interact with the response information, for example by marking strategies as tried or requesting additional information, and may transmit such interaction data back to the server as feedback for model improvement or system monitoring.

In these embodiments, the server does not merely automate a human mental process. The server implements a specific, non-conventional data processing architecture in which structured linguistic preprocessing, feature extraction, prompt generation, generative model invocation, and rule-based decision making are integrated into a unified pipeline. The server improves computer technology in several ways:
(1) The server reduces communication load and processing latency by embedding feature information and task specifications into a single prompt sentence, enabling a single generative AI model invocation to perform multiple tasks (health state estimation, severity estimation, coping content generation, and decision prediction), instead of multiple separate model calls.
(2) The server improves accuracy and consistency by deriving explicit feature information from the description information and supplying it as part of the analysis target content. This structured guidance reduces variance in the generative AI model's output and leads to more stable and repeatable predictions compared to naive use of raw text.
(3) The server enhances computational efficiency by using feature-based decision rules to post-process model outputs, thus avoiding repeated model invocations for thresholding and classification tasks. The combined architecture shortens computation time and reduces resource usage on the server hardware.
(4) The server achieves improved error handling and robustness by enforcing output templates and parsing rules, which transform free-form text generated by the generative AI model into machine-usable analysis result information. This structured post-processing allows the server to detect malformed outputs and apply corrective handling, which is not achievable by a simple human-in-the-loop approach.
(5) The server introduces non-human, non-intuitive processing steps, such as large-scale embedding-based feature representation, multi-head self-attention computations, and gradient-based weight optimization during training, which are specific to computer hardware and cannot be performed as-is by human operators. These steps contribute directly to the improved predictive capability and speed of the system.

These improvements yield technical effects including faster inference times, higher estimation accuracy for health states, reduced error rates in severity assessment, and lower network and computation load due to consolidated prompt design and unified model usage.

The system therefore provides more than a mere automation of human judgment; it implements a specialized computer-centric architecture and algorithmic pipeline, using a generative AI model in a constrained, task-driven manner that enhances the operation of the computer system itself.

Various modifications and alternative embodiments may be adopted without departing from the scope of the invention. For example, the server may employ different neural network architectures such as encoder-only language models or encoder-decoder sequence-to-sequence models. The server may choose different tokenization schemes such as word-based tokenization, subword tokenization, or character-based tokenization depending on the target language. The server may replace or supplement rule-based feature extraction with supervised learning models for phrase classification. The server may use alternative decision criteria for medical visit recommendation, such as multi-class severity levels or risk scoring models.

In another embodiment, the server may maintain a model registry and dynamically select among multiple generative AI models based on language, domain, or resource constraints. In yet another embodiment, the server may incorporate additional modules for anomaly detection, monitoring the distribution of severity scores over time to adjust thresholds and update safety rules. These and similar variations may be implemented while maintaining the core configuration in which the server generates a task-specific prompt sentence incorporating structured and feature information, uses a generative AI model as a controlled processing component, and generates structured analysis result information and response information accordingly.

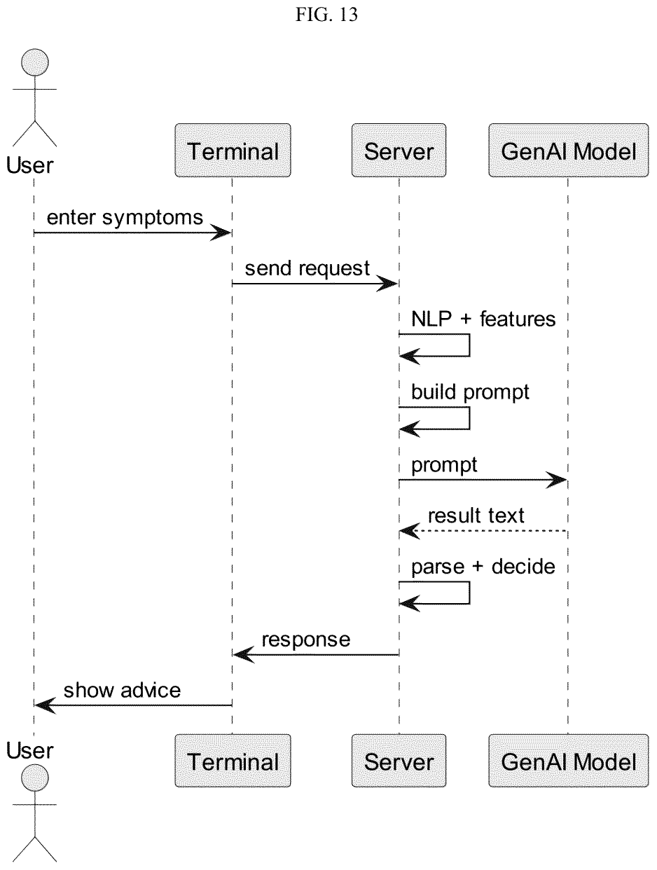

The following describes the processing flow using FIG. 13.

### Step 1

The user operates the terminal to input description information. The user launches an application on the terminal and types natural language text representing symptoms or problems into an input field. The input consists of at least one sentence, such as “Recently, I don't feel like doing anything.” or “In the morning, it is hard to get out of bed and I feel constantly tired.” The output of this step is description information held in the terminal's local memory as a text string.

### Step 2

The terminal generates a request payload including the description information. The terminal obtains a user identifier, a timestamp, and a language identifier from local storage or system APIs, and combines these with the description information to form structured data. The input of this step is the text string entered by the user and stored profile or system data; the terminal performs data formatting and serialization into a structured object, such as a key-value set.

The output of this step is a serialized request payload ready for transmission.

### Step 3

The terminal transmits the request payload to the server. The terminal uses a communication module to send the serialized payload to a predefined network address via a secure protocol.

The input of this step is the request payload created in Step 2; the terminal performs network communication operations including connection establishment and data transfer. The output of this step is a network message delivered to the server containing the description information and associated metadata.

### Step 4

The server receives and validates the request payload. The server's communication interface accepts the network message and passes it to an application process. The input of this step is the serialized request payload received over the network; the server performs deserialization to reconstruct the structured data, checks presence and format of required fields, and discards or flags malformed requests. The output of this step is a validated internal representation of the request, including the description information, user identifier, timestamp, and language identifier.

### Step 5

The server performs natural language preprocessing on the description information. The server takes the text string as input and applies natural language processing operations, such as tokenization, part-of-speech tagging, lemmatization, and dependency parsing, using an NLP library. The server transforms the raw character sequence into a sequence of tokens with linguistic annotations and constructs syntactic structures. The output of this step is structured information comprising token lists, tag lists, dependency relations, and extracted phrases stored in a data structure.

### Step 6

The server generates feature information based on the structured information. The input of this step is the structured information produced in Step 5. The server applies rule-based pattern detection and statistical analysis to identify symptom-related indicators, such as low motivation, fatigue, or negative affect. The server may compute numerical embeddings using a text encoder associated with the generative AI model and associate these embeddings with the description information. The server thus performs data derivation and feature extraction, converting linguistic structures into machine-usable indicators and vectors. The output of this step is feature information including flags, categories, and numerical vectors associated with the description information.

### Step 7

The server constructs analysis target content from the description information and feature information. The input of this step is the original text and the derived feature information. The server aggregates these elements into a unified data object that explicitly represents both the user's words and the interpreted symptom patterns. The server may organize the content into fields such as “raw_text,” “symptom_flags,” and “embedding_vector.” The data operation in this step is logical aggregation and structuring of heterogeneous data into a single analysis target content object. The output of this step is the analysis target content stored in memory.

### Step 8

The server generates a prompt sentence for the generative AI model. The server takes the analysis target content as input and converts part of the feature information into textual descriptions, such as “low motivation =true” or “fatigue_indicator =true.” The server then composes an instruction specifying required tasks, appends the textualized features, and appends the user's original description information to form a coherent prompt sentence. The data processing in this step involves template-based text composition and concatenation operations. The output of this step is a prompt sentence that explicitly instructs the generative AI model regarding health state estimation, severity scoring, and optional coping content generation.

### Step 9

The server encodes the prompt sentence into model-specific input data. The input of this step is the prompt sentence generated in Step 8. The server uses a tokenizer associated with the generative AI model to convert the prompt sentence into token identifiers and constructs attention masks and other auxiliary tensors required by the model. The server thereby performs symbol-to-index mapping and tensor construction operations. The output of this step is a set of model input tensors representing the prompt sentence in a numerical form suitable for the generative AI model.

### Step 10

The server performs inference using the generative AI model. The server supplies the model input tensors from Step 9 to the generative AI model executed on a processor and, if available, an accelerator. The input of this step is the numerical representation of the prompt sentence. The generative AI model processes the tensors through multiple neural network layers, computing attention weights and intermediate representations by matrix multiplications and nonlinear transformations. The model then produces output token distributions and generates output token sequences according to a decoding algorithm. The output of this step is generated text containing analysis result information, including at least a health state label, an explanation, and a severity indication.

### Step 11

The server parses the generated text to obtain structured analysis result information. The input of this step is the free-form or semi-structured text output from the generative AI model. The server scans the text for defined markers such as “Health state:”, “Explanation:”, and “Severity:” and extracts the content following each marker. The server converts the severity fragment into a numeric value and stores the label and explanation in separate fields.

The data processing in this step is text segmentation, pattern recognition, and type conversion. The output of this step is analysis result information structured into health state estimation information, severity information, and an associated explanation.

### Step 12

The server determines the necessity of recommending a visit to a medical institution. The server takes as input the severity information extracted in Step 11 and the original description information or its structured representation from Step 5. The server compares the severity value with predefined numeric thresholds and scans the description information for predetermined expressions indicating high risk. The server applies conditional logic to decide whether the combination of severity and expressions meets a criterion for recommendation. The data operation consists of threshold comparison, pattern matching, and logical evaluation. The output of this step is a determination result indicating whether a recommendation to visit a medical institution should be included.

### Step 13

The server generates temporary coping content based on the analysis result information. The input of this step is the health state estimation information, severity information, and the user's description information. The server may compose a new prompt sentence describing the estimated health state and requesting a specific number of short coping strategies, and then perform encoding, inference, and parsing similarly to Steps 8-11, or may extract coping-related segments from a combined output. The server filters, truncates, and formats the generated coping strategies, removing content that violates predefined rules. The data processing involves further prompt generation, model inference, text extraction, and rule-based filtering. The output of this step is a set of temporary coping items expressed as concise text.

### Step 14

The server constructs response information for the terminal. The input of this step consists of the analysis result information from Step 11, the determination result from Step 12, and the temporary coping content from Step 13. The server assembles these elements into a unified response structure, assigning each item to a designated field, such as “health_state_label,” “health_state_explanation,” “severity_score,” “coping_strategies,” and “visit_recommendation_message.” The operation in this step is structured data composition and formatting for transmission. The output of this step is response information ready to be sent to the terminal.

### Step 15

The server transmits the response information to the terminal. The input of this step is the structured response information created in Step 14. The server serializes this structure into a transmissible format and uses the communication interface to send it to the terminal over the network. The data processing involves serialization and network transmission operations. The output of this step is a network message that delivers the response information to the terminal.

### Step 16

The terminal receives and decodes the response information. The input of this step is the network message emitted by the server. The terminal's communication module accepts the message and passes it to the application, which deserializes the payload to reconstruct the individual fields of the response information. The terminal thus performs network reception, parsing, and deserialization. The output of this step is an internal representation of the response information that can be used for display.

### Step 17

The terminal displays the response information to the user. The input of this step is the internal representation obtained in Step 16. The terminal arranges the health state label, explanation, severity score, coping strategies, and visit recommendation message into a user interface layout and renders them on the display. The data operation in this step is mapping structured fields to visual elements and generating drawing commands for the display hardware. The output of this step is a visual presentation that enables the user to read and act on the generated content.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented advisory systems that use natural language text as input typically either (i) apply rule-based pattern matching and fixed templates, which lack flexibility and personalization, or (ii) directly forward raw user text to a generative AI model and display the returned response without meaningful pre-processing or control. In both cases, the computing system fails to exploit structured symptom and emotion information and fails to exercise fine-grained control over the behavior of the generative AI model. As a result, such systems often produce responses that are inconsistent in quality, insufficiently tailored to the user's actual health state or emotional state, or overly generic.

Further, when free-form user text is passed directly to a generative AI model, the underlying computing resources are not used efficiently. The model may generate excessively long or irrelevant responses, and server-side components cannot easily adapt prompts to different scenarios such as health support and purchase support. This leads to increased computational load, increased latency, and difficulty in guaranteeing predictable behavior. In particular, there is no systematic mechanism for the server to transform unstructured user text into machine-interpretable analysis information and then generate scenario-specific prompt sentences that tightly constrain and guide the generative AI model.

Additionally, known systems do not adequately integrate multi-stage inference, in which symptom information and emotion information are jointly extracted by machine learning models and then fed, in a structured way, into prompt sentences for the generative AI model.

Without this integration, the system cannot consistently generate safe and context-appropriate output information such as temporary coping methods, behavioral guidelines, or purchase-related advice. The absence of such a pipeline causes technical problems, including poor controllability of generated content, unnecessary repeated calls to the generative AI model, and suboptimal use of computational resources on the server.

Accordingly, there is a need for an improved computer-implemented system that transforms unstructured user text into structured analysis information including symptom information, health-state or disease-state estimation, and emotional-state estimation, and that uses this analysis information to generate controlled, scenario-dependent prompt sentences for a generative AI model. Such a system should improve the technical operation of the server and associated models by reducing irrelevant generation, enabling scenario-adaptive guidance, and producing output information that is more predictable and more closely aligned with the user's actual state.

The specific processing by the specific processing unit 290 of the data processing device 12 in Application Example 2 is realized by the following means.

The present invention provides a server comprising a processor configured to receive, from a user terminal, character information representing a health state or an emotional state of a user; to perform natural language processing on the character information to structure the character information by morphological analysis or part-of-speech tagging and to extract symptom information and emotion information; to estimate, on the basis of the extracted symptom information and emotion information, a health state or disease state and an emotional state by using a machine learning model, and to generate analysis information including an estimation result and the character information; to generate a prompt sentence including the analysis information, the prompt sentence instructing a generative artificial intelligence model to generate advice in accordance with the health state or the emotional state; to input the generated prompt sentence into the generative artificial intelligence model, to acquire a response text from the generative artificial intelligence model, and to generate output information including a temporary coping method or an action guideline on the basis of the response text; and to transmit the output information to the user terminal so as to be displayed on the user terminal. This enables the server to convert unstructured user input into machine-interpretable analysis information, to generate scenario-controlled prompt sentences that guide the generative AI model in a predictable manner, and to improve the technical operation of the computer system by reducing unnecessary computation, enhancing controllability and relevance of generated content, and providing more consistent and context-appropriate assistance.

The term “user terminal” refers to an information processing apparatus operated by a user, such as a computing device including at least an input unit, a display unit, and a communication unit, which transmits character information to a server and receives output information from the server.

The term “character information” refers to digital text data representing a user's statement, including at least one sequence of characters that expresses a health state, a disease state, a symptom, an emotional state, or a purchasing intention.

The term “health state” refers to an overall condition of a user's physical or mental status, represented in an abstract form such as “healthy,” “mildly unwell,” or “high stress level,” and not limited to a specific medical diagnosis.

The term “disease state” refers to a state indicative of a possible disorder or illness of a user, expressed as a class, label, or category, such as “common cold,” “influenza,” or “depressive tendency,” without necessarily constituting a confirmed medical diagnosis.

The term “emotional state” refers to a psychological condition or feeling of a user, represented by a label such as “sad,” “anxious,” “calm,” “stressed,” or “uncertain,” which is inferred from character information.

The term “natural language processing” refers to a series of computational procedures that transform unstructured text into structured data, including at least morphological analysis, tokenization, part-of-speech tagging, and extraction of linguistic features.

The term “morphological analysis” refers to a process of segmenting text into minimal linguistic units and determining attributes of each unit, such as word boundaries, base forms, and grammatical categories.

The term “part-of-speech tagging” refers to a process of assigning grammatical categories, such as noun, verb, adjective, or adverb, to each token in text data.

The term “symptom information” refers to structured data representing one or more symptoms or problems reported by a user, which are extracted from character information and can be used as input features for subsequent estimation or classification.

The term “emotion information” refers to structured data representing one or more emotional indicators of a user, which are extracted from character information and can be used as input features for emotional-state estimation.

The term “machine learning model” refers to a computational model, trained on training data, that receives feature data as input and outputs at least one prediction, probability distribution, or label, such as a health state, a disease state, or an emotional state.

The term “analysis information” refers to aggregated data including at least character information provided by a user and one or more estimation results derived from the character information, such as an estimated health state, an estimated disease state, or an estimated emotional state.

The term “generative artificial intelligence model” refers to a learned computational model configured to generate natural language text in response to an input, such as a prompt sentence, and including at least a language model trained on large-scale text data.

The term “prompt sentence” refers to a text sequence or structured instruction provided to a generative artificial intelligence model, the text sequence including at least a part of the analysis information and specifying a task to be performed by the generative artificial intelligence model.

The term “advice” refers to textual content generated for a user by a generative artificial intelligence model, including at least explanatory information, suggestions, or recommendations tailored to a health state, a disease state, an emotional state, or a purchasing intention.

The term “response text” refers to output text generated by a generative artificial intelligence model in response to a prompt sentence, before any post-processing by a server.

The term “output information” refers to data generated by a server on the basis of a response text, including at least one of a temporary coping method, an action guideline, a recommendation, or a notice that is transmitted to a user terminal.

The term “temporary coping method” refers to a short-term measure or set of measures suggested to a user, such as rest, hydration, relaxation techniques, or information-seeking actions, which is intended to alleviate or manage a reported symptom or emotional state on a temporary basis.

The term “action guideline” refers to a recommendation or instruction specifying a course of behavior for a user, which may include steps to be taken in relation to health, mental condition, or purchasing behavior.

The term “scenario” refers to a processing context or usage mode, such as a health support scenario or a purchase support scenario, which is used by a processor to determine how to configure a prompt sentence and how to interpret estimation results.

The term “health support scenario” refers to a scenario in which the system is configured to provide advice related to health, symptoms, or emotional burden, and to generate temporary coping methods based on an estimated health state or disease state.

The term “purchase support scenario” refers to a scenario in which the system is configured to provide advice related to purchasing behavior, including reflection on needs, comparison of options, or mitigation of emotional bias.

The term “rule” refers to at least one predetermined condition or set of conditions applied to input data, such as thresholds or logical expressions, for determining an outcome, including whether to recommend a visit to a medical or professional institution.

The term “decision model” refers to a computational model that receives at least one estimation result as input and outputs a decision, such as whether a recommendation for visiting a medical institution or a professional institution should be issued.

The term “medical institution” refers to an organization or facility that provides medical services by qualified personnel, including hospitals, clinics, and similar healthcare providers.

The term “professional institution” refers to an organization or facility that provides specialized support services, such as psychological counseling centers, mental health support centers, or consumer counseling services.

The term “recommendation” refers to information indicating that a user should consider taking a particular action, such as visiting a medical institution or consulting a professional institution, on the basis of at least one estimation result.

The term “server” refers to an electronic information processing apparatus, including at least one processor, a memory, and a communication interface, which executes the processes of receiving character information from a user terminal, generating analysis information and prompt sentences, communicating with a generative artificial intelligence model, and transmitting output information to the user terminal.

In one embodiment, a server implements the claimed system by executing a computer program on electronic hardware including at least one processor, a main memory, a non-volatile storage unit, and a communication interface. The server communicatively connects to at least one user terminal over a network such as the Internet using a secure transport protocol. The server stores executable instructions, trained model parameters, and configuration data in the non-volatile storage unit, and loads them into the main memory at runtime.

A user operates a terminal such as a smartphone, tablet, or personal computer. The terminal includes at least an input device, a display device, a communication module, and a storage unit. The terminal executes a client application, for example a native mobile application or a browser-based web application. The client application presents input fields and buttons on the display device, allows the user to enter character information representing a health state or emotional state, and transmits the character information to the server via the communication module using a network protocol such as HTTPS.

A user enters free-form text, such as “Lately, I just can't seem to get motivated to do anything.”, “I have a headache and fever.”, or “I'm not sure if I should buy this product.” into the terminal. The terminal encapsulates this character information with metadata such as a user identifier, a scenario identifier (for example, health support or purchase support), and a language code, and sends it to the server. By using structured request messages, the terminal enables the server to apply the appropriate processing pipeline.

The server uses software components implemented, for example, in a programming language such as Python running on an operating system such as a general-purpose server operating system. The server loads a natural language processing library, such as a general-purpose NLP toolkit, into memory. The server configures an NLP pipeline that includes a tokenizer, a morphological analyzer, and a part-of-speech tagger. The tokenizer segments the character information into tokens. The morphological analyzer determines base forms and inflection attributes of each token. The part-of-speech tagger assigns grammatical categories such as noun, verb, adjective, and adverb.

The server stores symptom lexicons and emotion lexicons as data structures such as hash tables or tries in memory. Each lexicon entry includes a token pattern, a normalized concept identifier, and optionally weights for different model features. The server uses these lexicons in combination with the NLP outputs to extract symptom information and emotion information from the character information. For example, the server maps “Headache” to a normalized symptom concept “headache” and maps “I don't feel like doing anything” to a normalized concept corresponding to “lack of motivation.” The use of lexicons linked to concept identifiers enables consistent feature indexing and reduces ambiguity compared to naïve keyword matching.

The server applies one or more machine learning models to estimate a health state or disease state and an emotional state. In one embodiment, the server uses a neural network classifier for health or disease state estimation. The classifier adopts a transformer-based text encoder architecture. The encoder maps token sequences to contextual embeddings using multiple self-attention layers. The server initializes the encoder with pretrained parameters obtained from training on a large corpus of general text and then fine-tunes the encoder on a corpus of annotated health descriptions. Above the encoder, the server mounts a fully connected layer that outputs a probability distribution over health or disease labels via a softmax function.

The server uses the symptom information and the contextual embeddings as input features.

For emotional-state estimation, the server uses a second neural network model with substantially similar architecture but trained on an emotion-labeled corpus. The server configures the emotional-state model to output probabilities over emotional labels such as “sad,” “anxious,” “calm,” “stressed,” and “uncertain.” In another embodiment, the server combines the outputs of the health-state model and the emotional-state model by a small decision network that receives concatenated logit vectors and produces a refined health state and emotional state. This multi-stage structure allows the server to capture interactions between symptoms and emotions that cannot be easily handled by rule-based systems.

The server trains the machine learning models offline using mini-batch gradient descent with an error function such as cross-entropy loss. The server minimizes the error function by updating network parameters according to an optimization algorithm such as Adam. The server applies data augmentation techniques, for example synonym replacement, random masking, and back-translation, to increase robustness against input variation. By using these specific training procedures, the server improves classification accuracy and generalization for noisy, user-generated text.

The server generates analysis information by aggregating the original character information, the normalized symptom information, the estimated health state or disease state with confidence scores, and the estimated emotional state with confidence scores into a structured record. The server may represent the analysis information as a record in memory including fields such as ‘raw_text’, ‘symptom_ids[]’, ‘health_label’, ‘health_confidence’, ‘emotion_label’, and ‘emotion_confidence’. This record forms a compact representation consumable by subsequent modules. Because the server maintains this internal structured format, it can apply deterministic checks and scenario-dependent routing before invoking a generative AI model, thereby reducing unnecessary invocations and improving computational efficiency.

The server generates a prompt sentence for a generative AI model on the basis of the analysis information. The server stores prompt templates for different scenarios in a template repository, for example as strings with placeholders. For a health support scenario, the server uses a template such as:

“User text: ‘[RAW_TEXT]’

Estimated Condition: [HEALTH_LABEL] (not a Diagnosis).

Emotion: [EMOTION_LABEL].

You are a cautious, non-diagnostic health assistant.

In Japanese,
1) briefly explain a few possible general causes,
2) suggest 2-3 temporary coping methods that are generally safe,
3) clearly state when the user should consider visiting a medical institution.

Do not provide a formal diagnosis or treatment plan.”

The server replaces the placeholders with the values from the analysis information. For a purchase support scenario, the server uses a template such as:

“User text: ‘[RAW_TEXT]’

Emotion: [EMOTION_LABEL].

You are a neutral assistant.

In Japanese,
help the user reflect on their needs, budget, and alternatives,
optionally recommend comparing reviews and taking time before deciding,
avoid pushing for purchase or making strong value judgments.”

By constructing the prompt sentence using structured analysis information, the server constrains the generative AI model to respond consistently within the intended domain and style. This structure also enables the server to adjust the prompt sentence automatically according to classification results, which is not feasible when the system merely forwards raw text to the model.

The server interfaces with a generative AI model deployed, for example, as a remote language model service or as a local model running on hardware accelerators. The generative AI model can be a large language model implementing a transformer architecture with multiple attention layers, feed-forward layers, and layer normalization. The model receives the prompt sentence as an input sequence and generates a response text token by token using probabilistic next-token prediction. The server controls generation parameters such as temperature, maximum token count, and stop conditions to balance creativity and determinism.

The server calls the generative AI model via an application programming interface, passing the prompt sentence and generation parameters. The server receives the response text as an output sequence of tokens, decodes the tokens into characters, and performs post-processing. The server may apply safety filters implemented as deterministic rules and shallow neural classifiers that detect prohibited content or over-confident diagnostic claims. When necessary, the server truncates or modifies parts of the response text to comply with safety policies.

The server generates output information by combining the sanitized response text with additional guidance derived from the analysis information. For example, if the health-state confidence exceeds a predefined threshold for a serious condition, the server appends a standardized statement recommending consultation with a medical institution. If the emotional state indicates severe distress, the server appends contact information or generic instructions for reaching out to professional institutions. The server builds the output information as structured data including at least an advice section, an optional coping-method list, and an optional recommendation section. The server then transmits the output information to the terminal.

The terminal receives the output information, parses the advice text and related fields, and displays them to the user in separate sections, such as “Possible Situation,” “Temporary Coping Methods,” and “When to Seek Help.” By structuring the display, the terminal improves user comprehension compared to presenting a single unstructured text block. In a purchase support scenario, the terminal displays reflective advice such as “consider your budget” or “check other reviews,” along with any associated product information provided by the server.

In another embodiment, the server manages a local knowledge base for standard coping methods and uses the generative AI model primarily for personalization and wording. The server retrieves generic coping instructions from a datastore when a specific health label or symptom pattern is recognized and includes them as part of the analysis information. The server then instructs the generative AI model, via the prompt sentence, to restate or adapt these instructions in tone and manner appropriate to the user's emotional state. This division of work reduces reliance on free-form generation and results in more predictable content, which is a technical improvement in controllability and safety.

The server improves processing speed and reduces communication load in several ways.

First, the server filters obviously irrelevant or malformed inputs before invoking the generative AI model, thereby avoiding unnecessary network calls and heavy computation.

Second, the server caches partial analysis results and model outputs keyed by normalized symptom patterns or prompt templates. When a new input closely matches a cached pattern, the server reuses portions of analysis information or response text, or uses them as few-shot examples in a compact prompt sentence, reducing repeated inference workload. Third, by embedding concise, structured analysis information in the prompt sentence, the server reduces the overall input token length, which lowers the computational complexity of transformer-based generative AI models and shortens latency.

The server improves estimation accuracy and stability through specific model structures and training procedures. The use of separate health-state and emotional-state classifiers, combined through a decision network, enables the server to enforce different decision boundaries for different tasks. The server can, for example, weight certain symptom features more heavily for health-state classification while emphasizing contextual and sentiment features for emotional-state classification. This targeted feature weighting is implemented as learned parameter matrices in the neural networks and is not achievable by simple rule-based systems. The server also employs early-stopping criteria, validation-set monitoring, and regularization techniques such as dropout and weight decay during training, thereby reducing overfitting and yielding more robust estimates for unseen user inputs.

The system provides technical improvements over conventional human-centered workflows and over naive AI integration for several reasons. A human operator cannot practically parse large volumes of text in real time, extract structured features, run high-dimensional classification, and construct constrained prompt sentences with consistent formatting and parameterization before every interaction. By contrast, the server automates these steps using computational modules that operate at machine speed and scale. Additionally, simple automation of human counseling or support would only translate the same reasoning patterns into code. In this system, the server implements explicit feature extraction, numeric representation, neural classification layers, and deterministic scenario-dependent prompt generation, which collectively form a non-conventional, computer-centric processing pipeline. This pipeline restructures and compresses input information before sending it to the generative AI model, thereby optimizing computation inside the model and reducing communication overhead.

Because the server uses structured analysis information to modulate the content of the prompt sentence and, in turn, constrain the behavior of the generative AI model, the system achieves a causal improvement in output quality and technical performance. The analysis information determines which scenario template is selected, which fields are included, and how severity flags are set. These flags influence the instructions in the prompt sentence, which in turn influence which parts of the generative AI model's parameter space are activated. As a result, the model generates responses that are shorter, more on-topic, and less likely to contain unsafe content. This reduces the need for additional filtering passes and re-generation cycles, thereby improving overall throughput and compute efficiency.

In another embodiment, the server implements alternative model architectures. The server may use a convolutional neural network with one-dimensional convolutions over token embeddings for symptom detection, combined with a recurrent neural network layer such as a gated recurrent unit for sequence modeling. The server may also implement a mixture-of-experts architecture in which specialized sub-models handle physical symptoms, mental health descriptions, or purchase-related expressions, and a gating network routes inputs among them based on coarse features. These variations still generate analysis information and prompt sentences as described above and therefore fall within the same technical concept.

In another embodiment, the server may run a local generative AI model on specialized hardware such as a graphics processing unit or tensor processing unit. The server manages memory allocation and model sharding across hardware devices to accommodate large parameter counts. The server configures low-precision arithmetic (for example, 8-bit quantized weights) to reduce memory footprint and inference time. In this configuration, the system not only improves advice quality but also demonstrates technical advantages in resource management and computational efficiency.

In another embodiment, the terminal may implement limited local preprocessing to offload work from the server. The terminal can perform preliminary tokenization or language detection, and can compress character information before transmission. The server, upon detecting this preprocessed format, adapts its pipeline to skip redundant steps. This division of labor reduces network bandwidth usage and lowers end-to-end latency, which is particularly beneficial for mobile networks with variable capacity.

In another embodiment, the server may log anonymized analysis information and model outcomes to a monitoring subsystem. The server can periodically retrain the machine learning models using updated data and can adjust rule thresholds for visit recommendations based on observed false-positive and false-negative rates. This feedback mechanism enables continuous improvement of model accuracy and system performance without changing the essential structure of the claimed invention.

Through these embodiments, the server, the terminal, and the user cooperate in a technically specific manner. The server executes a defined sequence of data transformations, neural computations, and prompt sentence constructions; the terminal acquires and presents information using concrete user interface and communication mechanisms; and the user interacts with the system by supplying character information and acting on the generated advice. Because the system as a whole improves the way computing resources are used for natural language understanding and controlled text generation, the invention goes beyond mere automation of human decision-making and instead provides concrete improvements in computer technology itself.

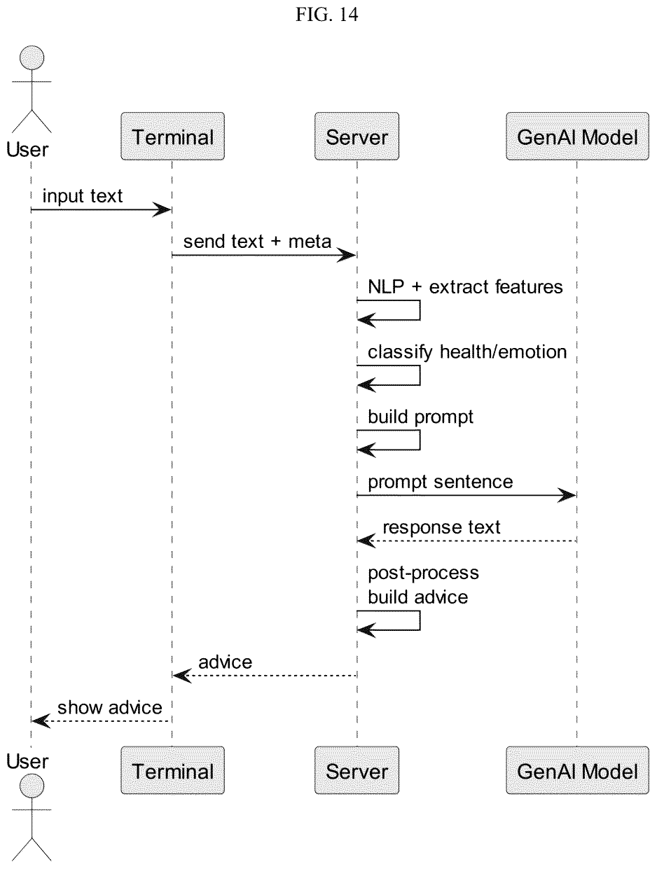

The following describes the processing flow using FIG. 14.

### Step 1

User operates the terminal to input character information.

User opens an application on the terminal and enters free-form text, such as “Lately, I just can't seem to get motivated to do anything.” “I have a headache and fever.”, or “I'm not sure whether I should buy this product.” into a text input field.

User may additionally select a scenario, such as a health support scenario or a purchase support scenario.

Input: raw character information and an optional scenario selection.

Output: user input data held in the terminal's memory, including the character information and scenario metadata.

### Step 2

Terminal transmits the user input data to the server.

Terminal encapsulates the character information, scenario identifier, and a user or session identifier into a request object, for example a JSON message.

Terminal sends the request object to the server over a secure network connection using a protocol such as HTTPS.

Input: user input data stored on the terminal.

Output: formatted request data transmitted to the server via the communication interface.

### Step 3

Server receives and validates the request data.

Server reads the request payload from the communication interface, parses the message, and checks for required fields, such as character information and scenario identifier.

Server may normalize the character encoding to a standard format and verify that the text length and content satisfy predefined constraints.

Input: request data from the terminal.

Output: validated character information and scenario metadata stored in server memory as internal variables or data structures.

### Step 4

Server performs natural language preprocessing on the character information.

Server calls a tokenizer and a morphological analyzer to segment the character information into tokens and to determine base forms and inflection attributes.

Server then calls a part-of-speech tagger to assign grammatical categories to each token and constructs a sequence of tokens with annotations.

Input: validated character information.

Output: annotated token sequence including token boundaries, base forms, and part-of-speech tags.

### Step 5

Server extracts symptom information and emotion information from the annotated token sequence.

Server compares tokens and phrases in the annotated sequence with entries in symptom and emotion lexicons stored in memory.

Server maps matching tokens or patterns to normalized concept identifiers and aggregates them into symptom information and emotion-related feature sets.

Input: annotated token sequence.

Output: structured symptom information and preliminary emotion information represented as lists of concept identifiers and associated attributes.

### Step 6

Server converts the extracted information into numerical feature vectors.

Server encodes the token sequence and the concept identifiers using an embedding model, such as a pretrained text encoder, to obtain dense vector representations.

Server concatenates contextual token embeddings, symptom embeddings, and emotion-related embeddings to form feature vectors for classification.

Input: symptom information, emotion-related feature sets, and annotated token sequence.

Output: health-state feature vector and emotional-state feature vector stored in server memory.

### Step 7

Server estimates a health state or disease state using a machine learning model.

Server inputs the health-state feature vector into a trained classifier, such as a neural network or another machine learning model, and performs forward propagation to compute class scores.

Server applies a softmax or similar function to obtain a probability distribution over health or disease labels and selects the label with the highest probability as the estimated state.

Input: health-state feature vector.

Output: estimated health or disease label and an associated confidence score.

### Step 8

Server estimates an emotional state using a machine learning model.

Server inputs the emotional-state feature vector into an emotion classifier and computes probabilities for a set of emotional labels, such as “sad,” “anxious,” or “uncertain.”

Server selects the emotional label with the highest probability and records its confidence score.

Input: emotional-state feature vector.

Output: estimated emotional label and an associated confidence score.

### Step 9

Server generates analysis information from the estimation results and original text.

Server constructs a structured record that includes the raw character information, symptom information, the estimated health or disease label, the health-state confidence score, the estimated emotional label, and the emotional-state confidence score.

Server stores this structured record in memory for use in subsequent processing steps.

Input: estimated health or disease label, estimated emotional label, symptom information, and raw character information.

Output: analysis information record encapsulating all relevant derived data.

### Step 10

Server selects a scenario and a prompt template based on the analysis information.

Server examines the scenario identifier received from the terminal and may also consult the analysis information, such as the estimated health state or emotional state, to confirm or refine the scenario.

Server chooses a prompt template appropriate for the scenario, for example a health support prompt template or a purchase support prompt template, from a template repository.

Input: analysis information and scenario identifier.

Output: selected prompt template and scenario-specific configuration parameters.

### Step 11

Server generates a prompt sentence for a generative AI model.

Server inserts values from the analysis information, such as the raw character information, the estimated health or disease state, and the estimated emotional state, into placeholder positions in the selected prompt template.

Server constructs a complete prompt sentence that also includes instructions defining the role of the generative AI model and constraints on its response style and content.

For example, the server may generate a prompt sentence such as:

“User text: ‘I have a headache and fever.’

Estimated condition: common cold or influenza (not a diagnosis).

Emotion: anxious.

You are a cautious, non-diagnostic health assistant.

In Japanese,
1) briefly explain a few possible general causes,
2) suggest 2-3 temporary coping methods that are generally safe,
3) clearly state when the user should consider visiting a medical institution.

Do not provide a formal diagnosis or treatment plan.”

Input: analysis information and prompt template.

Output: fully constructed prompt sentence stored as a text sequence.

### Step 12

Server transmits the prompt sentence to the generative AI model and obtains a response text.

Server creates a request to the generative AI model, including the prompt sentence and generation parameters such as maximum output length and temperature.

Server sends the request via an application programming interface to a remote or local generative AI model and waits for the completion of inference.

Input: prompt sentence and generation parameters.

Output: response text generated by the generative AI model and received by the server.

### Step 13

Server post-processes the response text and generates output information.

Server examines the response text for compliance with safety or content rules, such as avoiding definitive diagnoses or disallowed expressions, and may remove or modify violating portions.

Server may append additional information derived from the analysis information, such as standardized visit recommendations when the estimated health or emotional state exceeds severity thresholds.

Input: response text and analysis information.

Output: output information that includes refined advice, temporary coping methods, and optional recommendations, represented as structured data and formatted text.

### Step 14

Server transmits the output information to the terminal.

Server serializes the output information into a response message and sends it over the network connection to the terminal that issued the original request.

Server may also log summary records of the interaction for monitoring or model improvement.

Input: output information.

Output: response message delivered to the terminal through the communication interface.

### Step 15

Terminal displays the output information to the user.

Terminal receives the response message, parses the advice text and any accompanying fields, and renders them on the display as distinct sections such as explanations, coping methods, and recommendations.

Terminal may also provide interactive elements, such as buttons to request further details or to initiate another query, based on the displayed advice.

Input: response message from the server.

Output: visual presentation of advice and recommendations on the terminal's display for the user.

### Step 16

User reviews the displayed advice and optionally initiates further interaction.

User reads the advice, temporary coping methods, and recommendations, and decides whether to rest, seek medical attention, reconsider a purchase decision, or perform another action.

User may input follow-up text, such as “The symptoms have persisted for three days.” or “Please tell me about other options.”, thereby creating new character information to be processed through the same series of steps.

Input: displayed output information.

Output: user decisions and optional new character information for a subsequent processing cycle.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

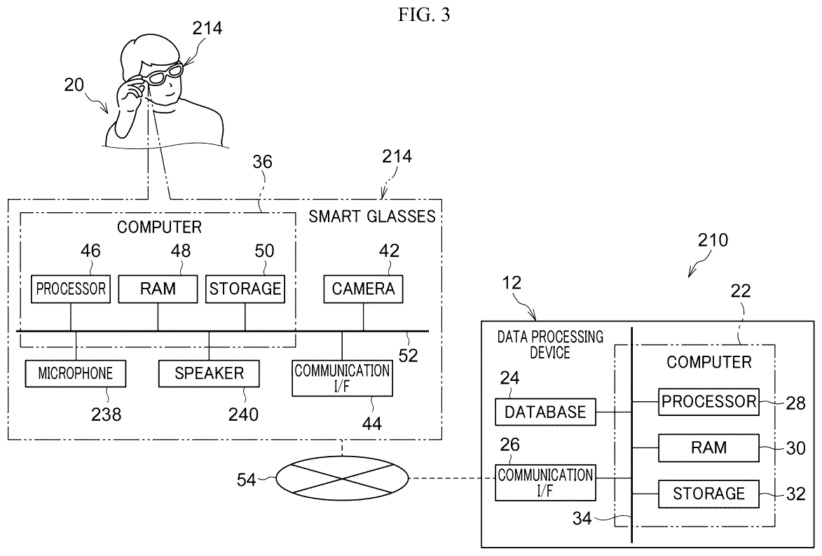

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

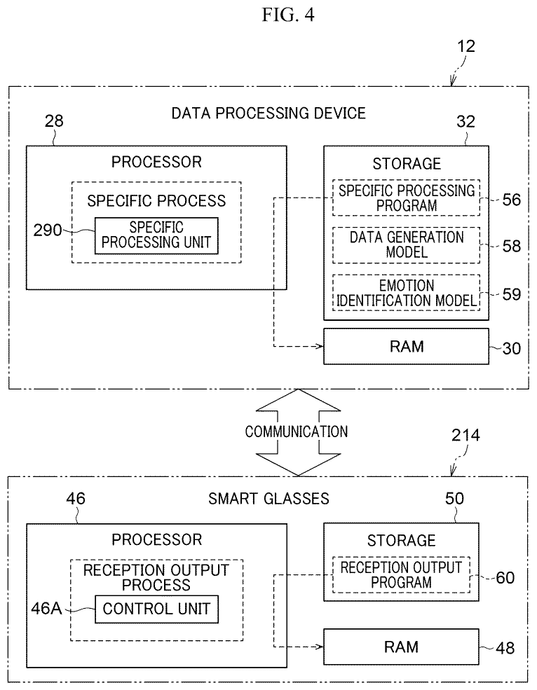

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

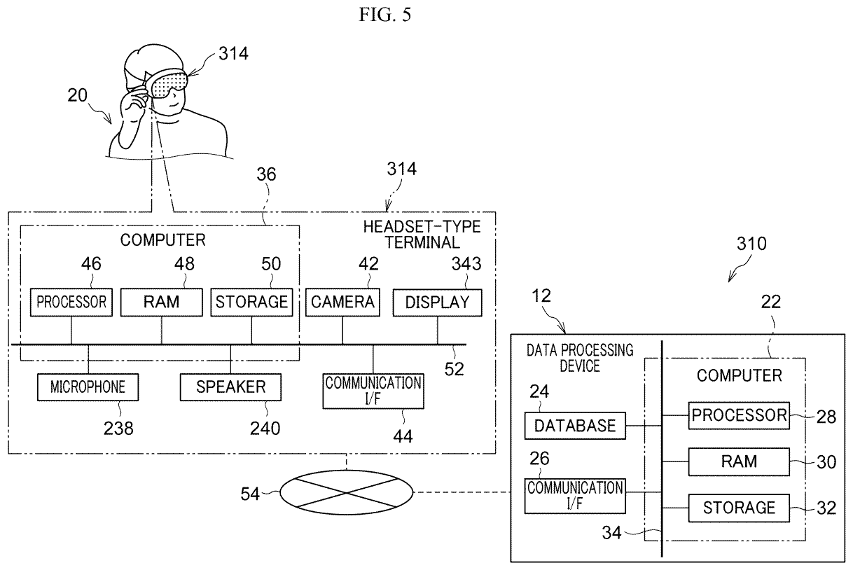

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

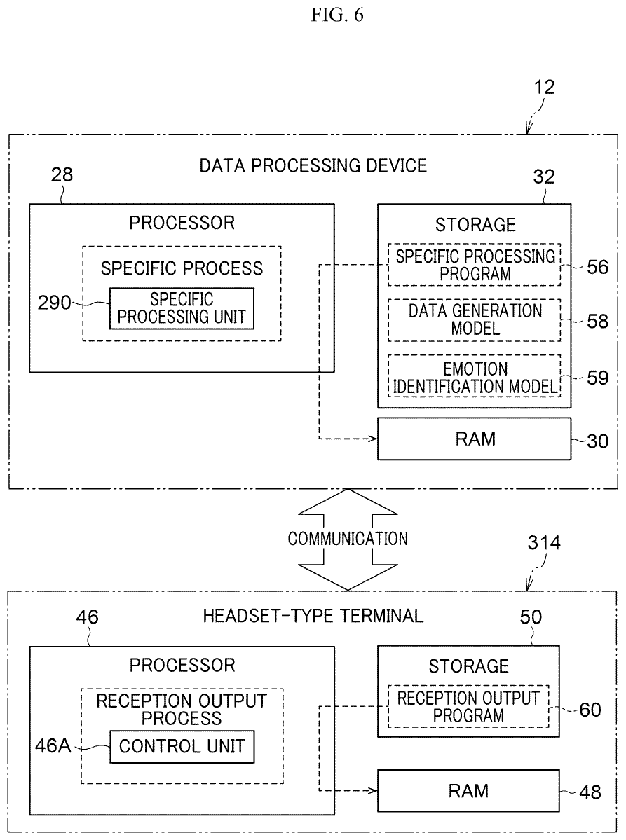

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

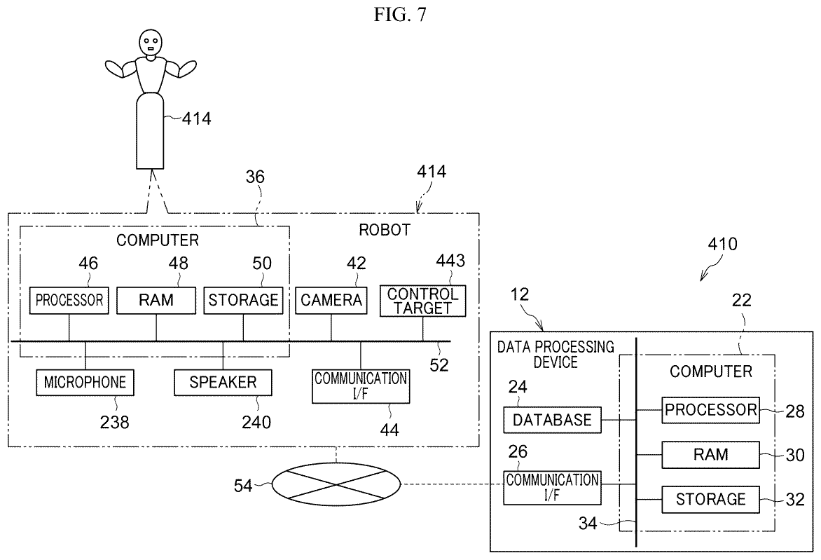

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

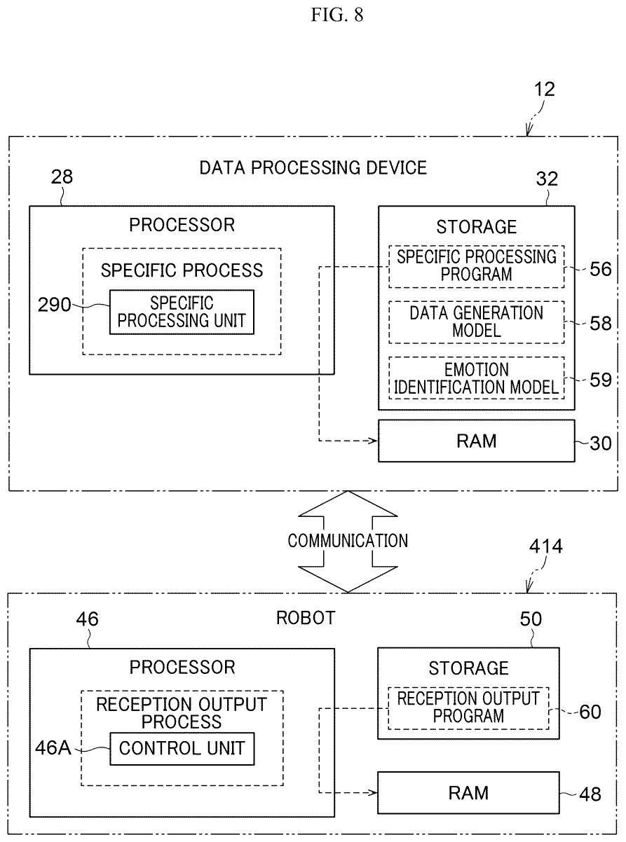

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

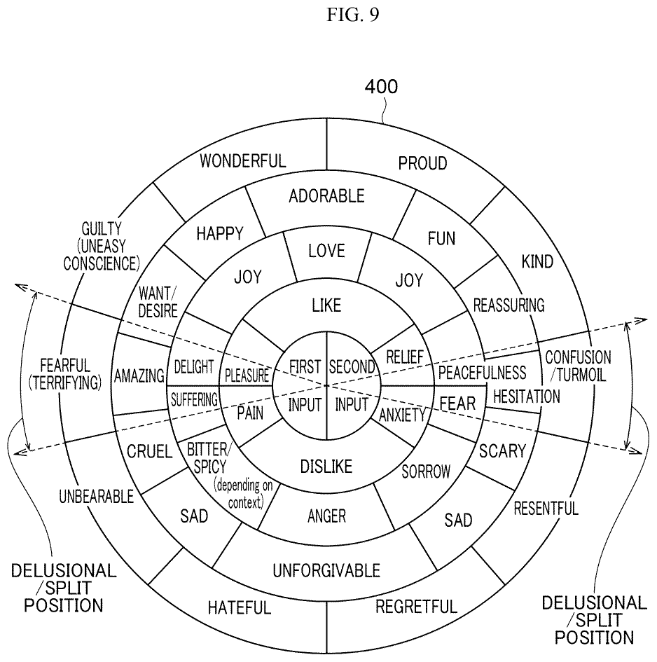

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

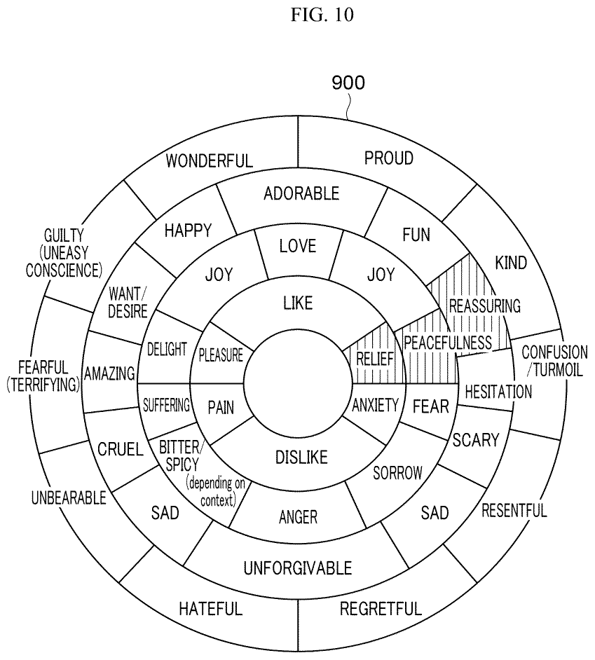

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire symptom information of a user from a terminal and transmit the symptom information from the terminal to a server by using a secure communication scheme via a communication control unit,
perform, at the server, natural language processing on the symptom information to divide the symptom information into word sequences, to extract important phrases based on part-of-speech information and grammatical information, and to convert the important phrases into numerical feature values,
input the numerical feature values to a machine learning model and estimate a classification result representing a disease state and an index representing severity of the symptoms, acquire, at the server, temporary response information associated with the disease state from an information storage unit based on the classification result and the index, and generate analysis information including the temporary response information and consultation recommendation information,
generate, at the server, a prompt sentence that instructs a generative information processing model regarding analytical content and output format based on the symptom information, the classification result, the index, and the temporary response information,
input, at the server, the prompt sentence to the generative information processing model, obtain generated text including an empathetic explanation sentence and an action suggestion sentence, and generate response information by integrating the generated text with the analysis information, and
transmit, from the server, the response information to the terminal by the secure communication scheme and cause the terminal to present the response information to the user by a display unit.

### Supplementary 2

The system according to supplementary 1,
wherein the processor is configured to
select the temporary response information based on the disease state included in the classification result, determine necessity of visiting a medical institution and urgency of the visit based on the index, and include a determination result in the response information.

### Supplementary 3

The system according to supplementary 1,
wherein the processor is configured to
perform a safety determination process on the generated text obtained from the generative information processing model, delete or correct an inappropriate expression in the generated text according to a predetermined condition, and transmit the corrected generated text as part of the response information to the terminal.

### Application Example 1

### Supplementary 1

A system comprising a processor,
wherein the processor is configured to
receive, from a terminal, character information indicating a user state or a user behavior,
perform processing on the received character information by using an information processing function for character-string processing to extract feature values relating to an emotion and a behavior, and convert the feature values into numerical information,
input the numerical information to a trained estimation function including a generative AI model to obtain an estimation result indicating a mental health state of the user,
generate a prompt sentence to be input to the generative AI model based on the estimation result and the character information,
input the generated prompt sentence to the generative AI model, obtain a response sentence including advice information that influences a purchasing behavior of the user from the generative AI model, and
transmit the obtained response sentence to the terminal so that the advice information is presented to the user.

### Supplementary 2

The system according to supplementary 1,
wherein the processor is configured to
classify the mental health state of the user as a stress level and a likelihood of occurrence of impulsive purchasing behavior based on the feature values, acquire advice policy information corresponding to a classification result from a storage function, and modify contents and an expression format of the prompt sentence based on the advice policy information.

### Supplementary 3

The system according to supplementary 1,
wherein the processor is configured to
control the terminal to display an input screen for receiving evaluation information or comment information with respect to the advice information from the user, receive the evaluation information or the comment information from the terminal, and update at least one operating condition of the trained estimation function or a function for generating the prompt sentence based on the evaluation information or the comment information collected from a plurality of users.

### Example 2

### Supplementary 1

A system comprising a processor,
wherein the processor is configured to
obtain description information input by a user, and
execute, by an information processing apparatus, natural language processing on the description information to perform preprocessing of the description information and to generate structured information and feature information based on the structured information, and
generate analysis target content including the description information and the feature information, and generate a prompt sentence for causing a generative information processing model to analyze the analysis target content, and
input the prompt sentence to the generative information processing model, cause the generative information processing model to generate analysis result information including health state estimation information relating to a health state of the user and severity information corresponding to the health state estimation information with respect to the analysis target content, and obtain the analysis result information, and
generate response information including temporary coping content based on the analysis result information, and output the response information to a user terminal.

### Supplementary 2

The system according to supplementary 1,
wherein the processor is configured to
determine necessity of recommending a visit to a medical institution, using the severity information included in the analysis result information and predetermined expressions in the description information as determination conditions, and include a determination result of the necessity in the response information.

### Supplementary 3

The system according to supplementary 1,
wherein the processor is configured to
generate the prompt sentence to explicitly indicate at least one task selected from a group consisting of generation of the health state estimation information, generation of the temporary coping content, and determination of the necessity of recommending the visit to the medical institution by the generative information processing model.

### Application Example 2

### Supplementary 1

A system comprising a processor,
wherein the processor is configured to
receive, from a user terminal, character information representing a health state or emotional state of a user, and perform natural language processing on the character information to structure the character information by morphological analysis or part-of-speech tagging and to extract symptom information and emotion information,
estimate, on the basis of the extracted symptom information and emotion information, a health state or disease state and an emotional state by using a machine learning model, and
generate analysis information including an estimation result and the character information,
generate a prompt sentence including the analysis information, the prompt sentence instructing a generative artificial intelligence model to generate advice in accordance with the health state or the emotional state,
input the generated prompt sentence into the generative artificial intelligence model, acquire a response text from the generative artificial intelligence model, and generate output information including a temporary coping method or an action guideline on the basis of the response text, and
transmit the output information to the user terminal so as to be displayed on the user terminal.

### Supplementary 2

The system according to supplementary 1,
wherein the processor is configured to change contents of the prompt sentence according to a scenario on the basis of the estimation result of the health state or disease state and the estimation result of the emotional state included in the analysis information, to cause the generative artificial intelligence model to generate, in a health support scenario, the temporary coping method corresponding to the health state, and to cause the generative artificial intelligence model to generate, in a purchase support scenario, advice regarding a purchasing behavior corresponding to the emotional state.

### Supplementary 3

The system according to supplementary 1,
wherein the processor is configured to determine, on the basis of the estimation result of the health state or disease state and the estimation result of the emotional state, necessity of recommending a visit to a medical institution or a professional institution by using a rule or a decision model, and to notify the user terminal of information regarding the recommendation together with the response text acquired from the generative artificial intelligence model.

What is claimed is:

1. A system comprising:
a communication interface coupled to a packet-switched network; and
circuitry configured to:
receive, via the communication interface, input text data from a terminal device;
execute a natural language processing operation on the input text data to extract structured information comprising keyword data and feature data;
input the feature data into a classification model to generate a classification result and a severity index;
generate a prompt sentence based on the input text data, the classification result, and the severity index, the prompt sentence being configured to instruct a generative neural network model to generate analysis output data;
transmit the prompt sentence to the generative neural network model and receive, from the generative neural network model, generated text data comprising an explanation segment and a recommendation segment; and
perform a safety determination process on the generated text data to produce verified output data, and transmit the verified output data to the terminal device via the communication interface.

2. The system according to claim 1, wherein the natural language processing operation comprises dividing the input text data into word sequences, extracting important phrases based on part-of-speech information and grammatical dependency information, and converting the important phrases into numerical feature vectors.

3. The system according to claim 2, wherein the classification model comprises a trained neural network that receives the numerical feature vectors as input and outputs a probability distribution over a plurality of classification categories, and the classification result is determined by selecting a category having a highest probability value.

4. The system according to claim 3, wherein the circuitry is configured to retrieve, from a storage device, response template data associated with the classification result and the severity index, and incorporate the response template data into the prompt sentence as context information for the generative neural network model.

5. The system according to claim 4, wherein the prompt sentence comprises a structured format including an analysis content field populated with the input text data and the classification result, an output format field specifying a required structure of the analysis output data, and a constraint field specifying prohibited expression patterns.

6. The system according to claim 5, wherein the circuitry is configured to determine, based on the severity index exceeding a predetermined threshold and detection of at least one predetermined keyword in the input text data, whether to include a referral notification in the verified output data.

7. The system according to claim 1, wherein the circuitry is configured to store the input text data, the classification result, and the generated text data as a session record in a storage device, and incorporate at least a portion of prior session records into a subsequent prompt sentence as interaction history data.

8. The system according to claim 7, wherein the circuitry is configured to maintain an interaction history comprising a sequence of prior prompt sentences and corresponding generated texts in the storage device, and incorporate at least a portion of the interaction history into a subsequent prompt sentence.

9. The system according to claim 8, wherein the generative neural network model comprises a transformer architecture having a plurality of self-attention layers, and the circuitry is configured to set inference parameters comprising at least a temperature value and a maximum output token count prior to transmitting the prompt sentence.

10. The system according to claim 9, wherein the circuitry is configured to apply a post-processing operation to the generated text data comprising at least one of: detecting a prohibited expression by matching against a stored pattern list, replacing the prohibited expression with a neutral alternative, and verifying that the generated text data satisfies a minimum and maximum length constraint.

11. The system according to claim 1, wherein the circuitry is configured to receive, via the communication interface, multimodal input data from the terminal device comprising at least one of image data and sensor data, and integrate the multimodal input data with the input text data to generate combined feature data for input to the classification model.

12. The system according to claim 11, wherein the circuitry is configured to extract emotion information from the input text data by applying a sentiment analysis model, and incorporate the emotion information into the prompt sentence such that the generative neural network model adjusts a tone and detail level of the generated text data.

13. The system according to claim 12, wherein the circuitry is configured to detect an anomaly in the generated text data by computing a consistency score between the generated text data and expected output parameters derived from the classification result, and trigger regeneration when the consistency score falls below a threshold value.

14. The system according to claim 13, wherein the regeneration comprises modifying the prompt sentence to include an indication of the detected inconsistency and retransmitting the modified prompt sentence to the generative neural network model.

15. The system according to claim 1, wherein the circuitry is configured to execute the natural language processing operation using morphological analysis to decompose the input text data into morphemes, apply part-of-speech tagging to each morpheme, and extract dependency relationships between morphemes using a syntactic parsing algorithm.

16. The system according to claim 1, wherein the circuitry is configured to receive follow-up input text data from the terminal device, compare the follow-up input text data with prior input text data stored in the storage device, and generate an updated prompt sentence that reflects changes detected between the follow-up input text data and the prior input text data.

17. The system according to claim 1, wherein the structured information further comprises at least one of: temporal information indicating when a described condition began, frequency information indicating recurrence patterns, and intensity information derived from adjective and adverb analysis of the input text data.

18. A system comprising:
a communication interface coupled to a packet-switched network; and
circuitry configured to:
receive, via the communication interface, input text data from a terminal device;
execute a natural language processing operation on the input text data comprising morphological analysis, part-of-speech tagging, and dependency parsing to generate structured feature data;
input the structured feature data into a classification model to generate a classification result and a severity index;
retrieve response template data from a storage device based on the classification result;
generate a prompt sentence comprising the input text data, the classification result, the severity index, and the response template data, the prompt sentence being configured to instruct a generative neural network model comprising a transformer architecture;
transmit the prompt sentence to the generative neural network model and receive generated text data;
perform a safety determination process on the generated text data comprising prohibited expression detection and length verification;
integrate the generated text data with the response template data to produce output data;
determine, based on the severity index and keyword detection in the input text data, whether to include a referral notification in the output data; and
transmit the output data to the terminal device via the communication interface.

19. The system according to claim 18, wherein the circuitry is configured to train the classification model using a training dataset comprising labeled input text samples paired with classification categories and severity values, the training applying a cross-entropy loss function and updating model parameters using a gradient-based optimization algorithm.

20. A method comprising:
receiving, via a communication interface coupled to a packet-switched network, input text data from a terminal device;
executing a natural language processing operation on the input text data to extract structured information comprising keyword data and feature data;
inputting the feature data into a classification model to generate a classification result and a severity index;
generating a prompt sentence based on the input text data, the classification result, and the severity index, the prompt sentence being configured to instruct a generative neural network model to generate analysis output data;
transmitting the prompt sentence to the generative neural network model and receiving, from the generative neural network model, generated text data comprising an explanation segment and a recommendation segment;
performing a safety determination process on the generated text data to produce verified output data; and
transmitting the verified output data to the terminal device via the communication interface.
